(19) United States
(12) Patent Application Publication
(10) Pub. No.: US 2008/0288462 A1
(43) Pub. Date: Nov. 20, 2008

(54) DATABASE SYSTEM AND DISPLAY METHOD ON INFORMATION TERMINAL

(76) Inventors: Norihiko NAONO, Tokyo (JP); Tomohisa Ota, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/122,254

(22) Filed: May 16, 2008

(30) Foreign Application Priority Data
May 16, 2007 (JP) P2007-130986
Apr. 21, 2008 (JP) P2008-110564

(51) Int. Cl. G06F 17/30

(52) U.S. Cl. 707/3; 707/E17.001

(57) ABSTRACT

A database system that includes a database for storing one or a plurality of relationships existing between a plurality of first instances belonging to a first entity and a plurality of second instances belonging to a second entity. A microprocessor is provided for searching the database when one or more of the first instances are selected as a first selected set for determining a first relationship existing between an instance in the first selected set and one of the plurality of the second instances, and when one or more of the second instances are selected as a second selected set for determining a second relationship existing between one of the plurality of first instances and a instance in the second selected set. A display device is included for displaying a first pane and a second pane, a first list which includes the plurality of the first instances in the first pane, a second list which includes the plurality of the second instances in the second pane, and the first relationship or the second relationship in the first pane or the second pane.

### CROSS REFERENCE TO RELATED APPLICATIONS

This application is base upon and claims the benefit of priorities from the prior Japanese Patent Application No. 2007-130986, filed on May 16, 2007 and the prior Japanese Patent Application No. 2008-110564, filed on Apr. 21, 2008, the entire contents of which are incorporated herein by reference.

### BACKGROUND OF THE INVENTION

1. Field of the Invention

The present invention is related to a database system and a display method on an information terminal. Specifically, the present invention is related to a database system, a data model, a relationship, a relational database, an information terminal, a display unit, an operating system, an application software, and a communication device.

2. Description of the Related Art

To model real events in a relational database, first, a logical data model, in which the events are represented logically, is usually created and constructed according to the relational database system requirements.

Entities to be represented in a relational database and a relationship representing the interrelation between entities are the basis of a logical data model. Entity-relationship diagrams (ER diagrams) for example, are used as a means to logically represent the relationship between a plurality of entities.

The mapping correspondence represented by a relationship between two entities can be one-to-one, one-to-many, or many-to-many. When designing a logical data model, a many-to-many relationship is often generated. Then, such many-to-many relationship is converted to a one-to-many relationship or a one-to-one relationship by introducing a new entity during the normalization process. That is, two primary keys of two entities having a many-to-many relationship are combined as a composite key and a new entity, in which this composite key is used as the primary key, is introduced. Using this new entity, a many-to-many relationship is eliminated and converted to a one-to-one relationship or a one-to-many relationship.

In this way, by eliminating a many-to-many relationship during the normalization process of a logical data model, non-normalized entities, which have two or more similar attributes are eliminated from the data model, and the data model is structured without redundancy as describe in the Japan Patent Laid-open Heisei 9-319629.

However, it is difficult to implement an intuitive display or manipulation of a many-to-many relationship using a one-to-many relationship usually used in a conventional relational database management system. This is because a new entity is introduced by the normalization process and such new entity is represented by a table, which is unnatural to a user of a database system.

As a result of the normalization process and the elimination of a many-to-many relationship, the number of instances belonging to the newly introduced entity generally becomes larger than the number of instances belonging to two entities that have represented a many-to-many relationship. For example, suppose that there is an n:m relationship between entity A with n number of instances and entity B with m number of instances. As a result of the normalization process, a new entity C is defined, and the number of instances belonging to entity C may become as many as most n×m. Further, when entity C is defined as a multi set, the number of instances may become more than n×m.

For example, when a user of a database system wishes to search and display only the instances belonging to entity B each of which has a relationship with a specific instance belonging to entity A, the user has to issue a query to search each instance of entity C, which has as a part of the composite key the primary key of the specific instance of entity A to which a search request is specified, from the above-mentioned instances belonging to entity C. Therefore the user must be aware of the existence and the structure of entity C.

Alternatively where the user of the database system wishes to search and display only the instances belonging to entity A each of which has a relationship with a specific instances of entity B, the user has to issue another query to search each instance belonging to entity C, which has as another part of the composite key the primary key of the specific instance of entity B to which a search request is specified, from the above-mentioned instances belonging to entity C.

Thus, the user of the database system has to refer to entity C, which is newly introduced by the normalization process, and this contradicts to the intuition of the user and causes some complications.

### BRIEF SUMMARY OF THE INVENTION

A database system according to one embodiment of the present invention comprises a database, the database storing one or a plurality of relationships existing between a plurality of first instances belonging to a first entity and a plurality of second instances belonging to a second entity; a microprocessor, the micro processor searching the database, when one or a plurality of first instances are selected as a first selected set among the plurality of first instances, for a first relationship existing between a instance in the first selected set and one of the plurality of second instances, and the microprocessor searching the database, when one or a plurality of second instances are selected as a second selected set among the plurality of second instances, for a second relationship existing between one of the plurality of first instances and an instance in the second selected set; and a display device, the display device displaying a first pane and a second pane, the display device displaying a first list which includes the plurality of first instances in the first pane and displaying a second list which includes the plurality of second instances in the second pane, and the display device displaying the first relationship or the second relationship in the first pane and/or the second pane.

A database system to another embodiment of the present invention comprises a database, the database storing one or a plurality of relationships between a plurality of first instances belonging to a first entity and a plurality of second instances belonging to a second entity; a microprocessor, the microprocessor searching the database, when a third instance and a fourth instance are selected from the plurality of first instances, for one or a plurality of fifth instances in the plurality of second instances wherein one or a plurality of first relationships exist between the one or the plurality of fifth instances and the third instance and/or between the one or the plurality of fifth instances and the fourth instance at a first condition, and searching the database for one or a plurality of sixth instances in the plurality of second instances wherein one or a plurality of second relationships exist between the one or the plurality of sixth instances and the third instance and/or between the one or the plurality of sixth instances and the fourth instance at a second condition; and a display device for displaying a first pane and a second pane, the display device displaying a first list which includes the plurality of first instances in the first pane and displaying a second list which includes the plurality of second instances in the second pane, the display device displaying the one or the plurality of first relationships, which exists between the one or the plurality of fifth instances and the third instance and/or between the one or the plurality of fifth instances and the fourth instance, in a first mode, and the display device displaying the one or the plurality of second relationships, which exists between the one or the plurality of sixth instances and the third instance and/or between the one or the plurality of sixth instances and the fourth instance, in a second mode.

A display method of one embodiment of the present invention, the method being executed in an information terminal having a database storing one or a plurality of relationships existing between a plurality of first instances belonging to a first entity and a plurality of second instances belonging to a second entity and a display device displaying a first pane and a second pane, the display device displaying a first list which includes the plurality of first instances in the first pane and displaying a second list which includes the plurality of second instances in the second pane, the display method comprising searching the database, when one or a plurality of first instances are selected as a first selected set among the plurality of first instances, for a first relationship existing between an instance in the first selected set and one of the plurality of second instances and displaying the first relationship on the display device; and searching the database, when one or a plurality of second instances are selected as a second selected set among the plurality of second instances, for a second relationship existing between one of the plurality of first instances and an instance in the second selected set and displaying the second relationship on the display device.

### BRIEF DESCRIPTION OF THE DRAWINGS

FIG. 1(a) shows an example of a many-to-many relationship.

FIG. 1(b) shows an example of a many-to-many relationship.

FIG. 2 is an ER diagram showing an example of a one-to-many relationship after the normalization process.

FIG. 3 is a diagram showing an example of display screen of a many-to-many relationship.

FIG. 4 is a diagram showing an example of display screen of a one-to-many relationship.

FIG. 5 is a diagram showing an example of display screen of a one-to-many inverse relationship.

FIG. 6 is a diagram of components of an information terminal.

FIG. 7 is a flowchart for explaining a process of an information terminal.

FIG. 8 is an example of a database selection screen.

FIG. 9(a) is an example of a display screen of a many-to-many relationship.

FIG. 9(b) is an example of a display screen of a many-to-many relationship.

FIG. 10 is an example of display screen of an inverse many-to-many relationship.

FIG. 11 is an example of selection method of a many-to-many relationship.

FIG. 12 is an example of deletion method of a many-to-many relationship.

FIG. 13 is a flowchart for explaining a process for selecting an instance.

FIG. 14 is a flowchart for explaining a process for displaying a relationship.

FIG. 15 is a flowchart for explaining a process for displaying a relationship.

FIG. 16 is a flowchart for explaining a process for displaying a changed relationship.

FIG. 17 is a flowchart for explaining a process for adding a relationship.

FIG. 18 is a flowchart for explaining a process for deleting a relationship.

FIG. 19(a) shows an example of display and manipulation of a database.

FIG. 19(b) shows an example of display and manipulation of a database.

FIG. 20 shows an example of the classification of tree structure.

FIG. 21 shows an example of a narrow-down method of search target by using the classification of tree structure.

FIG. 22 shows an example of a classification through tagging.

FIG. 23(a) shows an example of a narrow-down of search target.

FIG. 23(b) shows an example of a narrow-down of search target.

FIG. 23(c) shows an example of a narrow-down of search target.

FIG. 24 shows an example of a narrow-down of search target.

FIG. 25(a) shows an example of a classification of search target.

FIG. 25(b) shows an example of a classification of search target.

### DETAILED DESCRIPTION OF THE INVENTION

The embodiments of the present invention are described below. Since the scope of the present invention is defined clearly according to the claims, the following description is given in order to illustrate by an example the topics of this invention, and the meaning of this description should not be taken as restrictive.

The present invention can be applied to various information terminals or communication terminals. Examples of such information terminals or such communication terminals are personal computers, servers, personal digital assistants, fixed-line telephones, cellular phones, game machines, televisions, video recorders, cameras, video cameras or portable music players. Not only the devices given here as examples but also other devices such as display devices with a graphical user interface (hereinafter referred to as GUI), and input devices such as buttons, keyboards, mouses, touch sensors, graphic tablets, track balls and joysticks that can control objects on the GUI can be used.

### EMBODIMENT 1

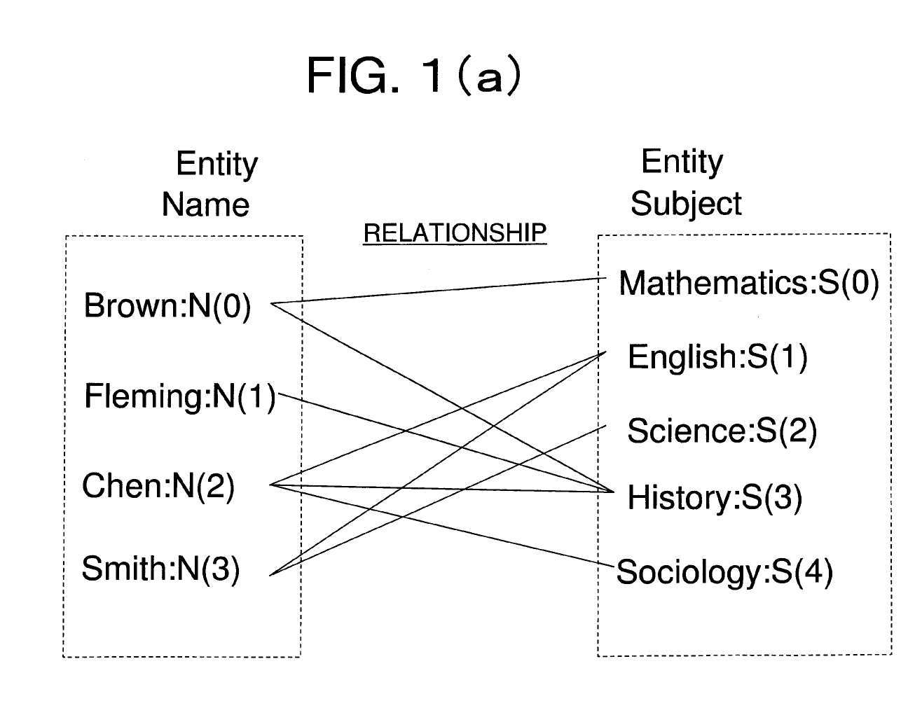

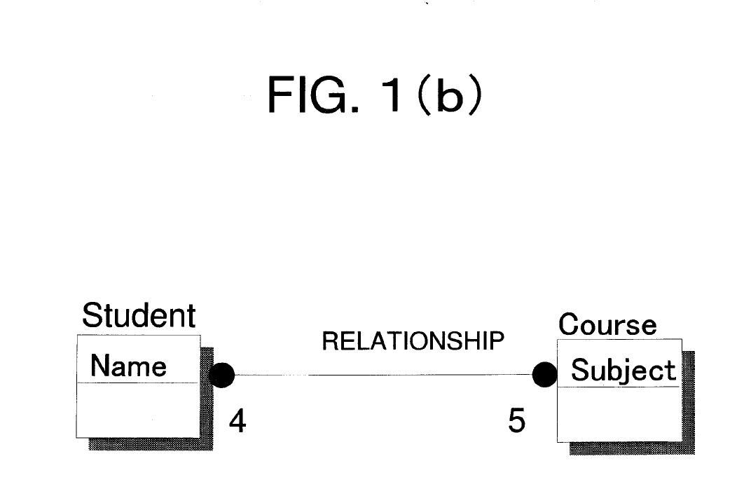

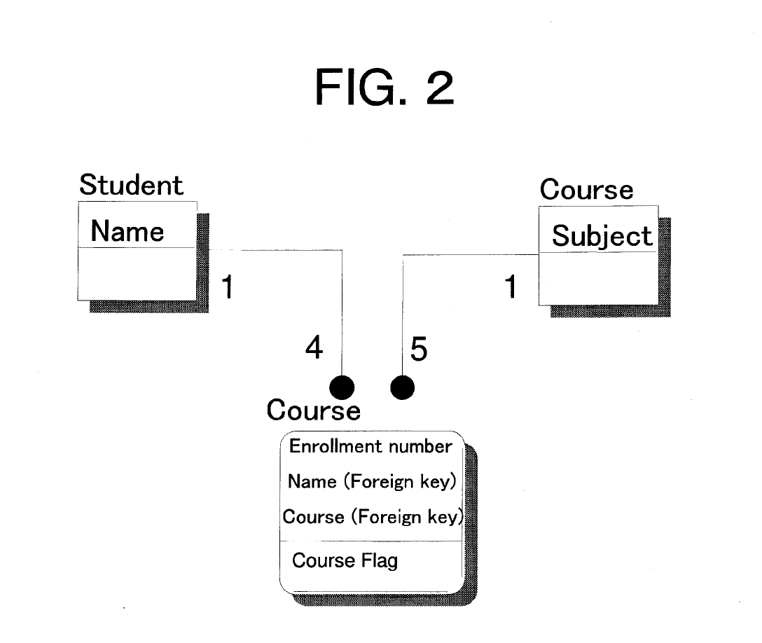

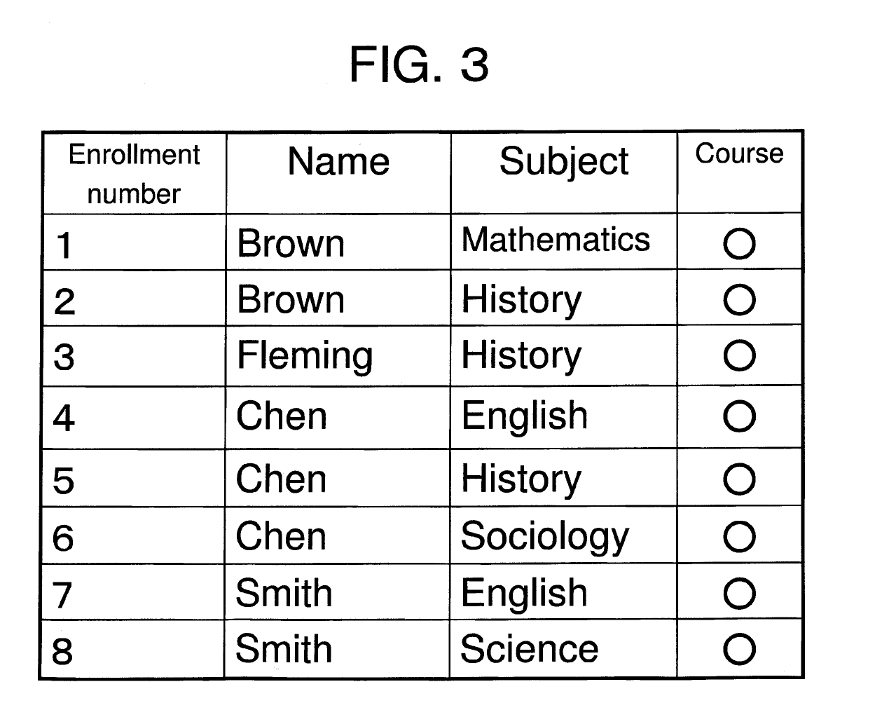

A explanation is firstly given to an example schematically shown in FIG. 1(a), which is referred to in the description of the embodiment one. Suppose that there is a many-to-many relationship between entity “Name” and entity “Subject” and that as shown in FIG. 1(a), “Brown”, “Fleming”, “Chen”, and “Smith” are four instances belonging to entity “Name” and that “Mathematics”, “English”, “Science”, “History”, and “Sociology”, are five instances belonging to entity “Subject.” In this case, the cardinal of the relationship between entity “Name” and entity “Subject” is represented as 4:5. Hereinafter, in order to simplify the subsequent flowcharts, in FIG. 1(a), every instance belonging to “Name” and “Subject” is shown as N (n) and S (n) respectively, where n is an integer. For example, N(0) is “Brown” and N(1) is “Fleming.” The ER diagram showing this relationship is drawn in FIG. 1(b). By applying the normalization process to this relationship, a new entity called “Course” is introduced and the relationship is converted to two one-to-many relationships: one from “Name” to “Course” and one from “Subject” to “Course.” The ER diagram showing this entity “Course” is drawn in FIG. 2 and the table representation of entity “Course” is shown in FIG. 3. By this normalization process, the redundancy between entity “Name” and entity “Subject” is eliminated. However, the number of instances belonging to the newly created entity “Course” is greater than the number of instances belonging to “Name” and “Subject.”

If a query command “SELECT*FROM Course;” in the SQL language is issued to display all relationships belonging to entity “Course”, a complicated table structure similar to that in FIG. 3 is obtained. Therefore, such a table structure is hard to grasp the relationships.

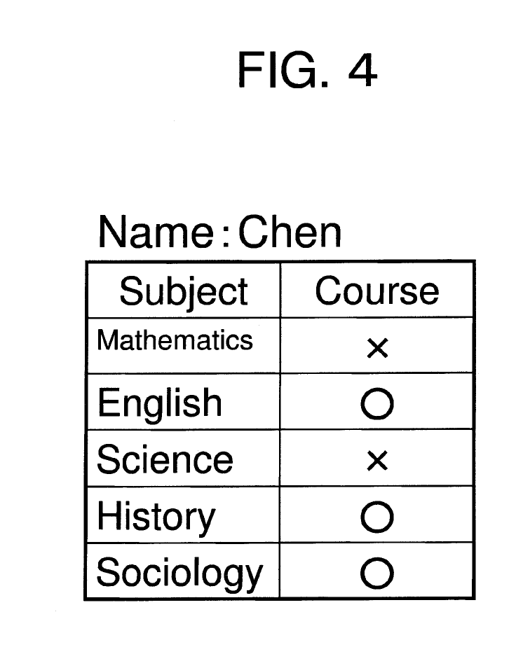

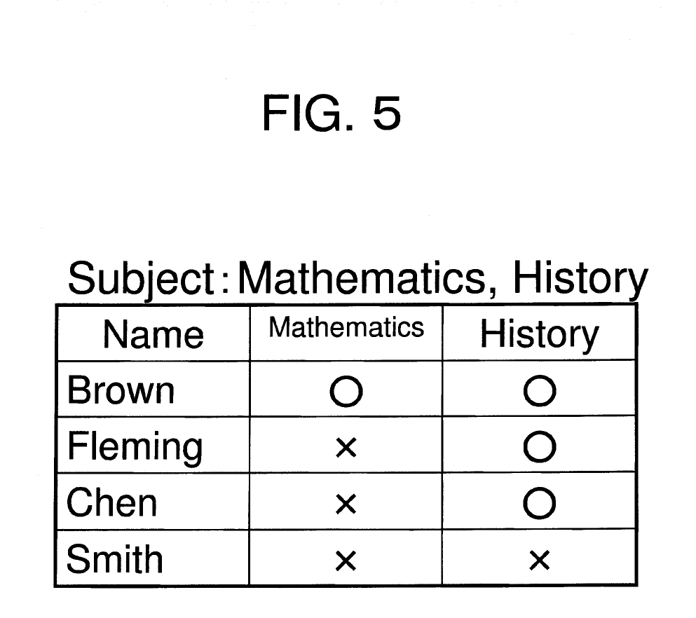

In such cases, if the subjects taken by the instance “Chen” are to be listed, the user of the database searches the “Course” by using “Chen” as a search key and the result displayed is as shown in FIG. 4. Further, if the names of persons who have taken “Mathematics” and “History” are to be listed, the user searches entity “Course” by using “Mathematics” and “History” as the search keys and the result displayed is as shown in FIG. 5. Further, when a many-to-many relationship between “Name” and “Subject” is to be created or updated, it should be updated after displaying one-to-many relationships as shown in FIG. 4 or FIG. 5. However, in the case of a conventional method, either of a one-to-many relationship such as from “Name” to “Subject” or “Subject” to “Name” is displayed on the screen. In such a case the user of the database must spend a lot of time for display or for input and it is difficult to display the entire picture of a many-to-many relationship as shown in FIG. 1(a).

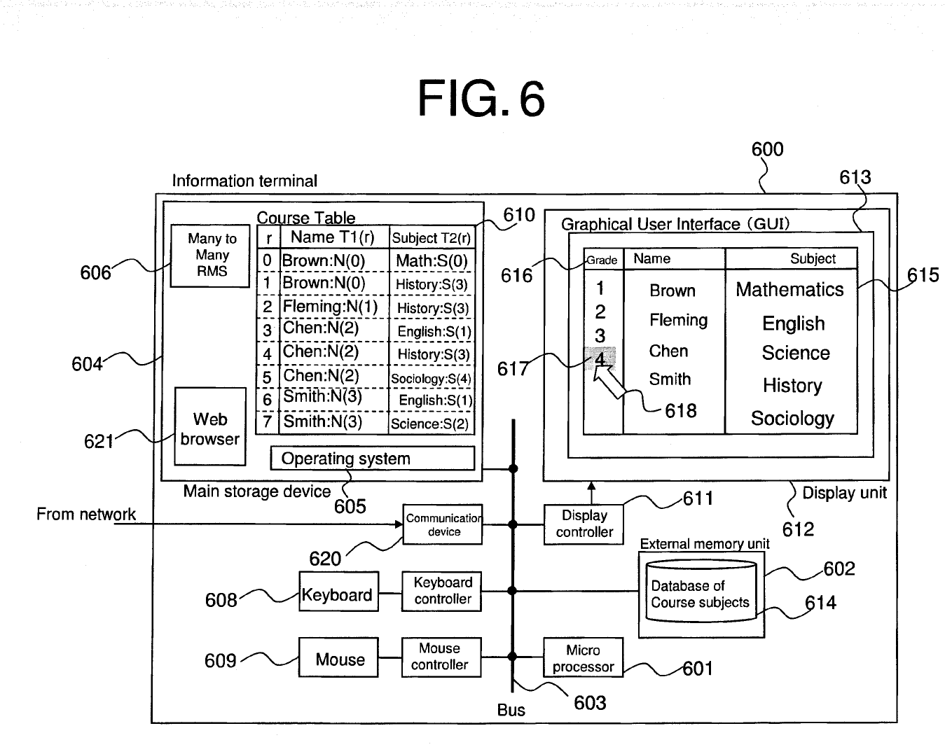

According to one embodiment of the present invention, the effects of the present invention can be obtained by coordinating each element which makes up the hardware along with the software (hereinafter referred to as a many-to-many RMS) for displaying, manipulating, or controlling a many-to-many relationship in the database. FIG. 6 shows the components of an information terminal in a block diagram as an example. The configuration shown in FIG. 6 is a typical example. It can be modified by adjusting with a specific implementation pattern and its restrictive meaning should not be taken. For example, other than the configuration, peripheral devices such as optical disk storage media, audio input/output devices, printers and similar devices can be connected to an information terminal. Further, the main functions of an information terminal can be information storage, processing, communication with other terminals or servers, or relay of information on the network.

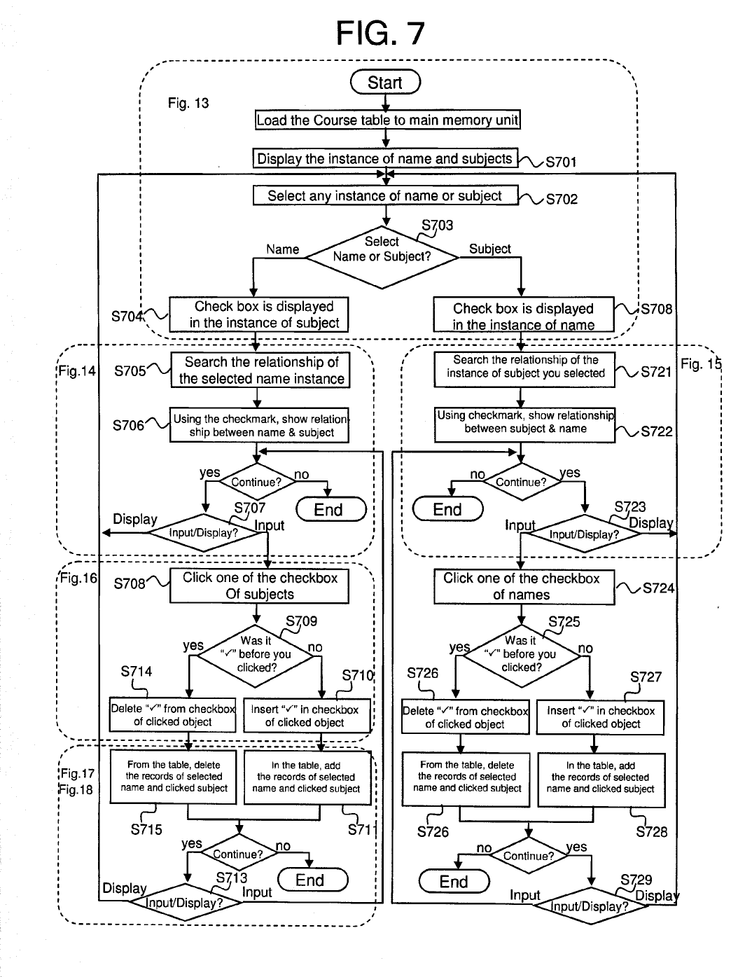

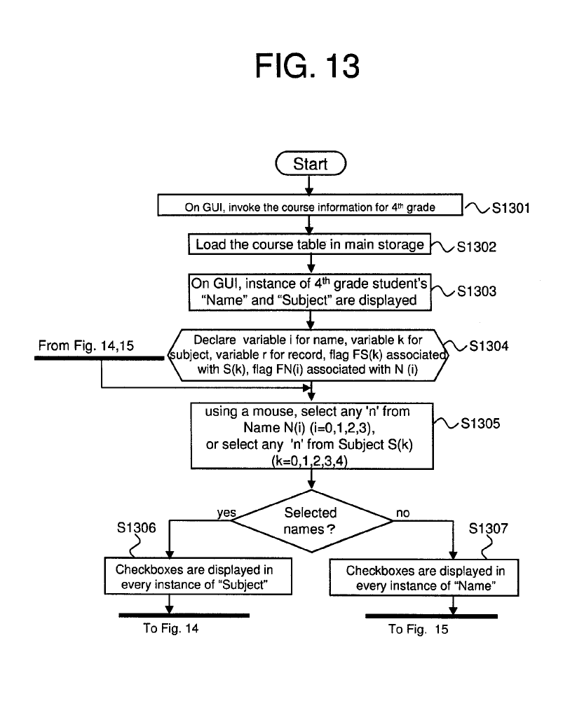

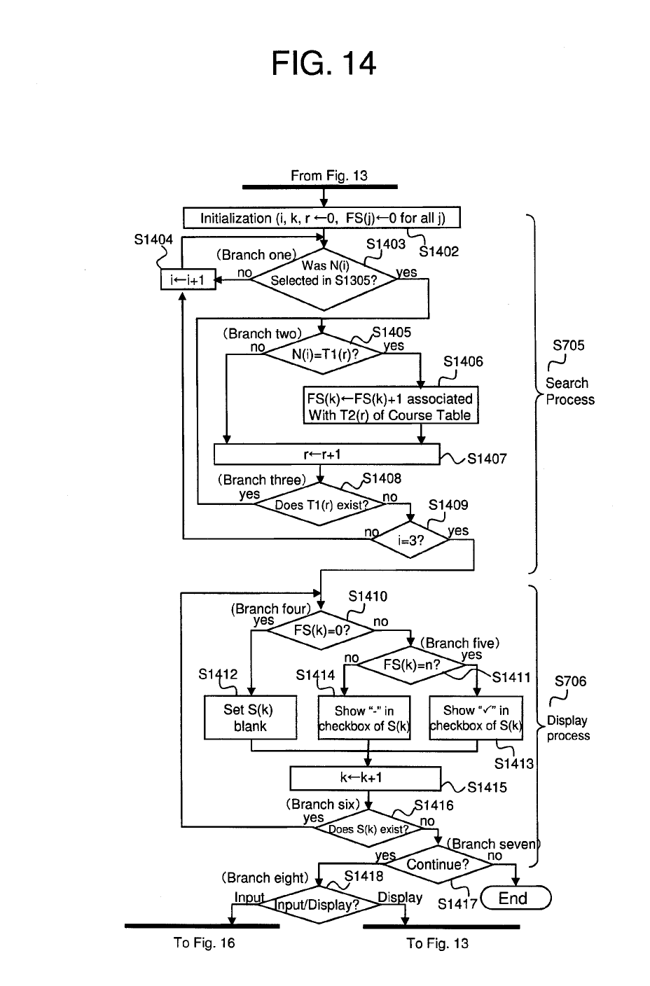

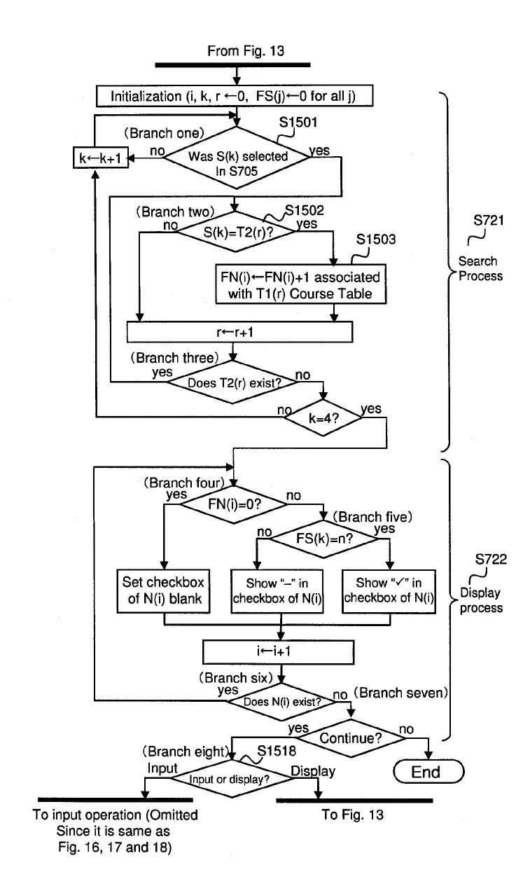

Next, an outline of a device for displaying and inputting of a many-to-many relationship in the present invention is described with references to the block diagram shown in FIG. 6 and the flowchart shown in FIG. 7. Then, a detailed description of the method by executing each step shown in FIG. 7 and how it is implemented by coordinating with the hardware resources shown in FIG. 6 as an example is given with references to the flowcharts shown in FIGS. 13, 14, 15, 16, 17 and 18.

In the example of the embodiment one, an information terminal has a microprocessor 601. In the processes described below, an application software loaded in a main memory unit 604 issues commands to an operating system 605 similarly installed in the main memory unit 604. These commands are executed by giving instructions to the microprocessor 601 through a bus 603.

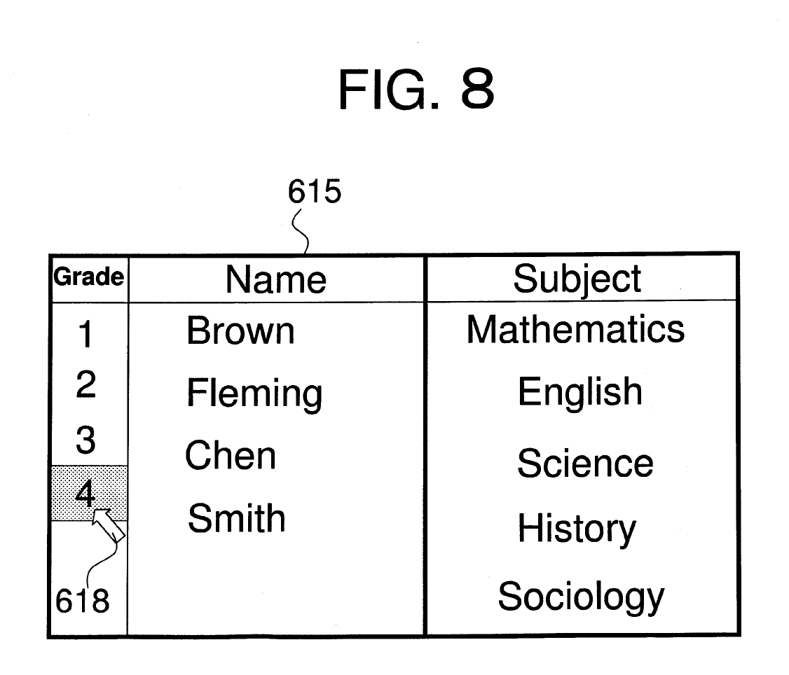

In a status where the operating system 605 mentioned above is loaded in the main memory unit 604, the many-to-many RMS 606 stored in an external memory unit is loaded in the main memory unit 604. When the user of this information terminal specifies information to be displayed or manipulated from a Course database stored in an external memory unit 602, by using keyboard 608 or mouse 609, the many-to-many RMS loads a part or complete information regarding an entity or a relationship included in the specified information in the main memory unit 604. In the example shown in FIG. 6, the information loaded as above is called Course Table 610. In this state, the many-to-many RMS 606 mentioned above displays each instance of entity “Name” and entity “Subject”, in the many-to-many RMS window 615 on the graphical user interface (hereinafter called as GUI) 613 displayed on display unit 612 as shown in FIG. 8 (Step S701).

That is, in the many-to-many RMS window 615, three regions are provided. These regions show titles: “Grade”, “Name”, and Subject” respectively In the region of “Grade”, a list containing “1”, “2”, “3”, and “4”, which are the instances of entity “Grade”, is listed. In the region of “Name”, a list containing “Brown”, “Fleming”, “Chen”, and “Smith”, which are the instances of entity “Name”, is listed. In the region of “Subject”, a list containing “Mathematics”, “English”, “Science”, “History”, and “Sociology”, which are the instances of entity “Subject”, is listed. A region in which one or more of instances of an entity are shown is called a pane. A pane is a part defined by sectioning a window by one or more of boarders. The boarders need not be shown explicitly and a pane need not contain a title. In the case that a pane contains a title, title may be shown above, below, or at a side of the instances. A pane may be realized a subwindow of a window, or a pane may be a window itself.

Further, in the description hereinafter, there are cases in which a pane and an entity the instances of which are shown in the pane are handled as equivalent. For example, there are cases in which an expression “entity E” is used instead of an expression “pane P in which one or more of instances of entity E are shown.”

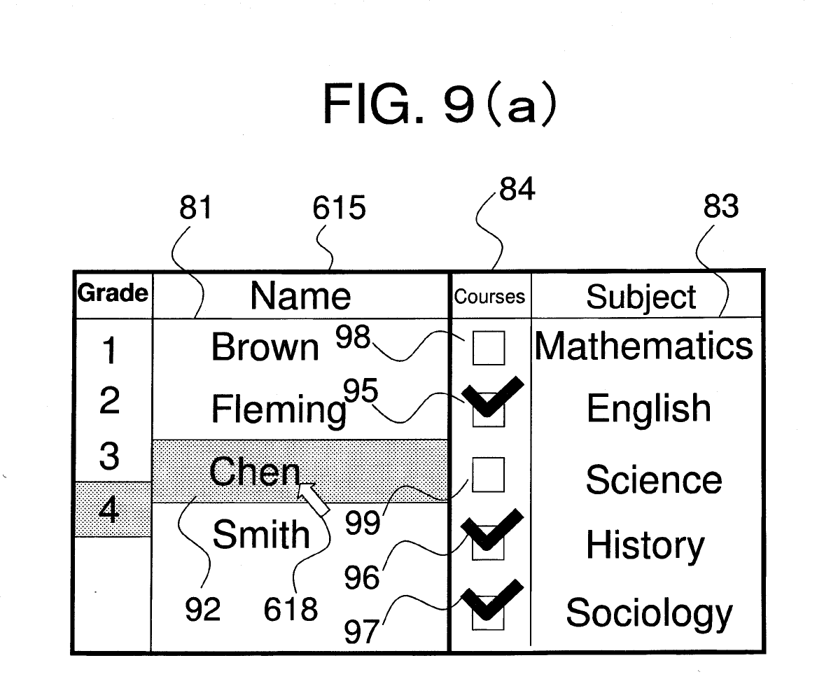

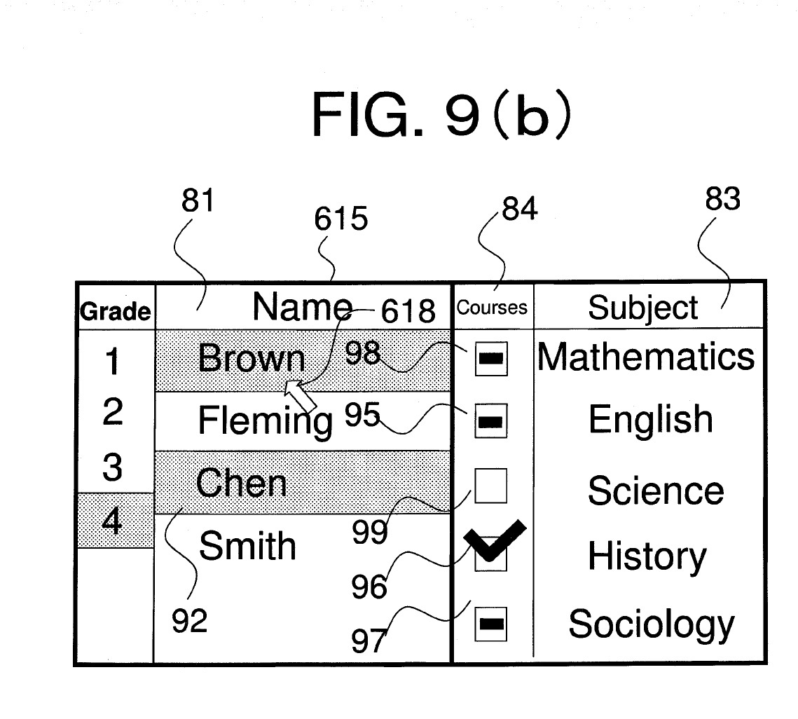

Subsequently, if the user of this information terminal selects one or more instances of “Name” or “Subject” among the displayed instances (Step S702), a check box is displayed in each instance of the entity that does not belong to the selected instance (Step S704 or Step S708). The many-to-many RMS searches the one or a plurality of instance relationships of the name that is selected from Course Table (Step S705 or Step S721) and the result is displayed by using the check mark (Step S706 or Step S722). As shown in the example of FIG. 9(a), instance “Chen” is selected from entity “Name” and as a result, check mark “✓” is displayed in “English”, “History” and “Sociology” among the instances belonging to entity “Subject”. As shown in Course Table 610 of FIG. 1 and FIG. 6 mentioned above, this indicates that “Chen” has taken “English”, “History”, and “Sociology”. The check box on the left side of “Mathematics”, “Science” is blank. This indicates that “Mathematics” and “Science” courses have not been taken by “Chen”.

Here, an instance relationship of the name “Chen” means that a tuple (or sometimes referred to as a record) exists in Course Table such that the tuple contains “Chen” as an instance belonging to entity “Name.” That is each tuple in Course Table represents an instance relationship. For the brevity of expressions, a word relationship is sometimes used to refer to an instance relationship. Further, “an instance of an entity” is used instead of writing “an instance belonging to an entity.”

For example, in FIG. 6 there is a tuple containing “Brown:N(0)” of entity “Name” and “Math:S(0)” of entity “Subject.” Therefore a relationship exists between “Brown:N(0)” and “Math:S(0).”

Also, multiple instances may be selected. For example, as shown in FIG. 9(b), two instances, “Brown” and “Chen” are selected from entity “Name”. Then, for these two instances, the relationships with entity “Subject” is displayed by using steps similar to that in the previous cases. Check mark “✓” 96 on the left side of “History” indicates that all selected instances of entity “Name”, here “Brown” and “Chen”, have taken “History”. Further, for example, the check mark “-” 98 on the left side of “Mathematics” indicates that a subset of selected instances of entity “Name”, here only “Brown”, has taken “Mathematics”. The step mentioned above is explained later in detail with the help of FIG. 13 and FIG. 14. Instead of using check mark “✓” or “-”, fonts for displaying “History”, “Mathematics”, etc. may be changed from the font for displaying “Science.”

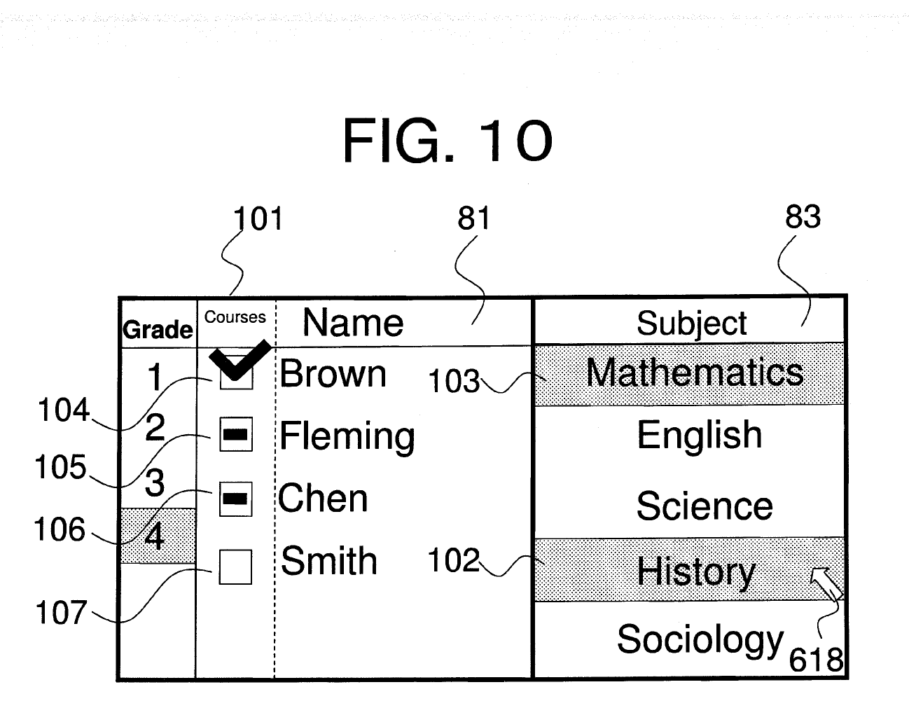

Further, the user of this information terminal can move the cursor 618 by using the mouse 609 at any time, and can select another one or more instances displayed on the many-to-many RMS window 615. The relationship among other instances including an opposite direction can also be displayed. For example, from the status shown in FIG. 9(a) or FIG. 9(b), in the example in FIG. 10, among the instances of entity “Subject” displayed in the many-to-many RMS window 615, “Mathematics” 103 and “History” 102 are selected. Then a many-to-many relationship from entity “Subject” to entity “Name” can be displayed similar to the case where the relationship from entity “Name” mentioned above to entity “Subject” (Steps S708, S709 and S710) is displayed. In the example in FIG. 10, the check mark “✓” 104 on the left side of “Brown” indicates that “Brown” has taken both “Mathematics” and “History”. Further, the check mark “-” on the left side of “Fleming” 105 indicates that Fleming has taken either “Mathematics” or “History” among the selected entity “Subject”. The step mentioned above is explained later in detail with the help of FIG. 13 and FIG. 15.

As mentioned above, in the information terminal according to the present invention, the user of this information terminal moves the cursor 618 of GUI 613 on the display device 612 with the help of the mouse 609; and a two-way many-to-many relationship between two entities can be displayed easily by just selecting one or more instances of one entity.

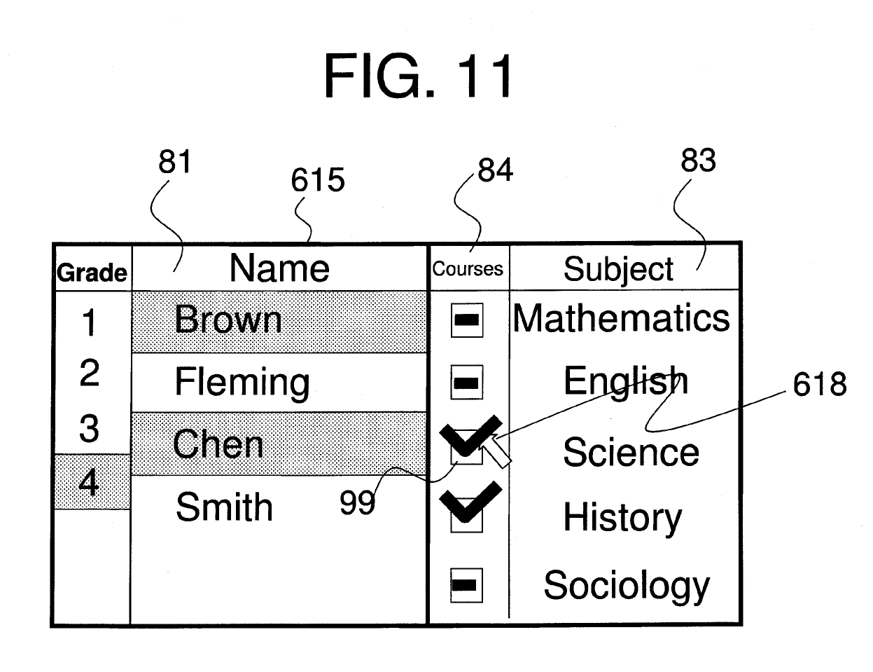

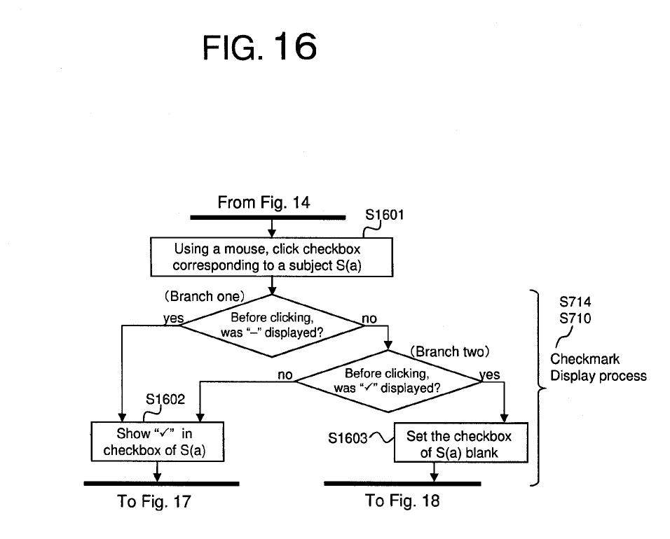

Further, according to this invention, not only the many-to-many relationship between two entities can be displayed in two way, but also the relationship can be updated, deleted, or inserted easily through above mentioned GUI 613. For example, starting from the status in FIG. 9(b), the following description is given. From the status in FIG. 9(b), the user of this information terminal moves the cursor up to the check box 99, which is on the left side of “Science” with the help of mouse 609 and selects the check box 99 by clicking the mouse (Step S708). Since the check box 99 is empty before clicking (Step S709), a check mark “✓” is displayed in the check box 99 (Step S710) and as a result, the many-to-many RMS window 615 becomes as shown in FIG. 11. Further, a combination of two instances “Brown” and “Chen” of entity “Name” selected in step S701, namely a tuple {“Brown”, “Science”} and a tuple {“Chen”, “Science”} are added as new relationships to Course Table 610 mentioned above (Step S711). The step mentioned above is explained later in detail with the help of FIG. 16 and FIG. 17.

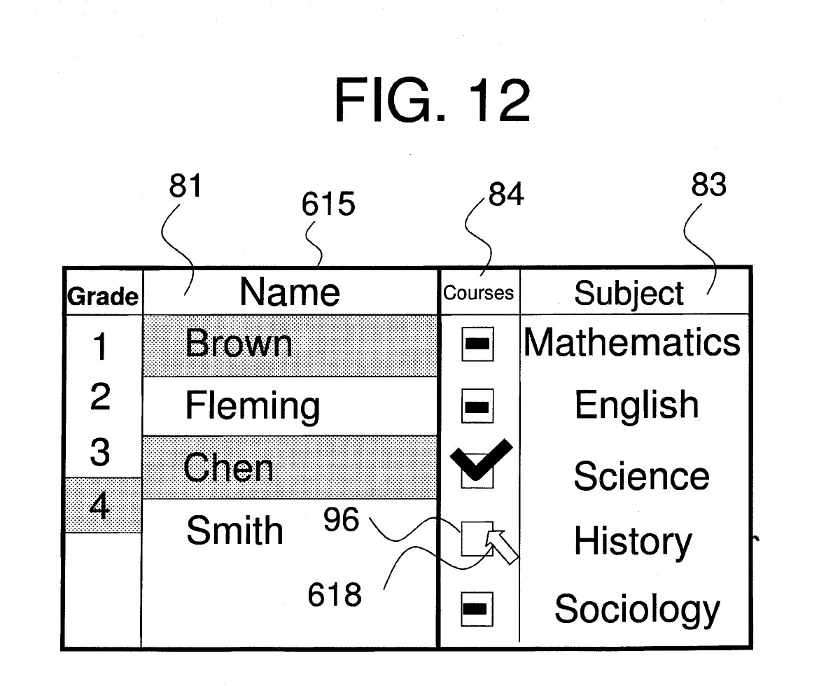

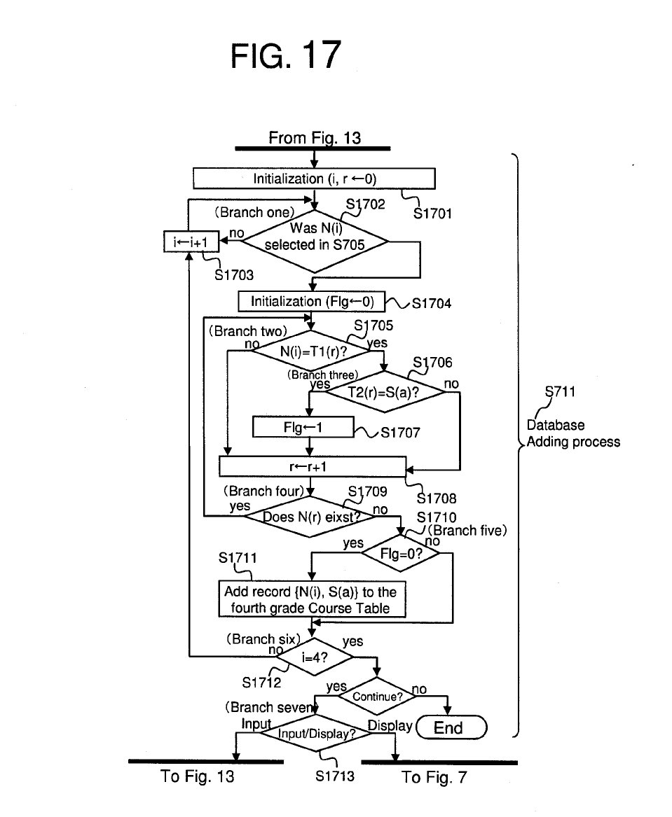

In this state, the user of this information terminal can select whether to update (to insert or to add or to delete) the relationship using the currently displayed window or to display other relationship (Step S713). For example, when the user continues o insert (or add) another relationship using the currently displayed window, in the status in FIG. 11 mentioned above, the user of this information terminal moves the cursor up to the check box 96 that is on the left side of “History”, for example, with the help of mouse 609 and selects the check box by clicking the mouse (Step S708). Since the check mark “✓” was displayed in the check box before clicking (Step S709), that check mark is deleted (Step S714) and as a result, the many-to-many RMS window becomes as displayed in FIG. 12. Further, when a different relationship is to be displayed, the process returns to step S702 rather than to step S713 mentioned above in FIG. 7. This selection of an update or a display can be performed easily by executing either of the operations such as clicking the check box on the many-to-many RMS window GUI or selecting any instance. The step mentioned above is explained later in detail with the help of FIG. 16 and FIG. 18.

Moreover, in this embodiment, check marks “✓” or “-” are used as symbols indicating the existence of one or more relationships between instances of entities. However, other symbols, icons, image data, characters, numeric characters etc. can also be used instead of check marks displayed in check boxes explained above. For example, in FIG. 10 referenced above, a two-way may-to-may relationship between instances of two entities can be easily displayed by using the method in which the number of subjects taken by each person is displayed in numeric characters in the checkbox on the left side of each instance of entity “Name” instead of check marks “✓” and “-”. The check box does not always need to be used for displaying and updating the many-to-many relationship between the instances of the entities, but a window, icon, figure wherein input and selection is possible, can also be used instead.

Further, in the explanation given so far with reference to FIG. 6, the basic principles of this invention is explained by using an example wherein a many-to-many RMS program and Course Table are stored in the main memory unit of an information terminal. However, the many-to-many RMS program and Course Table can also be stored in any memory unit within a server that is connected to another network terminal through a communication device 620. In such a case, if a user of the information terminal selects or clicks an instance or a check box displayed on the many-to-many RMS window 613 by using keyboard 608 or mouse 609, a web browser converts it to a command and sends the command to the server through the communication device 620. After receiving the command, the server executes the processes such as search, add, delete, or modify similar to that of each step mentioned above for the Course Table, which is in the memory unit and sends the contents of the many-to-many RMS window to be displayed to this information terminal through the network. The information terminal, receiving the contents of the many-to-many RMS window by communication device 620, displays the many-to-many RMS window on GUI 613 of the display device using the web browser 621 as mentioned above.

Next, the method which is executed in each step as shown in FIG. 7, in coordination with the hardware resources shown as an example in FIG. 6 is explained in detail with references to the flowcharts in FIG. 13, FIG. 14, FIG. 15, FIG. 16, FIG. 17 and FIG. 18.

First, the steps executed before the selection of an arbitrary instance are explained by referring to FIG. 13. The many-to-many RMS 606, which is stored in the external memory unit is loaded in the main memory unit 604 when the operating system 605 mentioned above is loaded in the main memory unit 604. Here, if the user of the information terminal specifies the information that is to be displayed or to be manipulated among the course database 614, which is stored in external memory unit 602, by using the keyboard 608 or the mouse 609, the entire or a part of the information related to the entities or the relationships, in which the specified information is contained, is loaded by the many-to-many RMS in the main memory unit 604. In the example in FIG. 6, by instructing through the many-to-many RMS 606, the user of the information terminal selects using the mouse 609 the item 617 indicating the fourth grade from the window 616 for grade selection in the many-to-many RMS window 615 for course that is displayed in Graphical User Interface 613 (Hereinafter, referred to GUI) that is displayed on display device 612 by display control device 611 (Step S1301). Then, the many-to-many RMS 606 searches the names of the fourth grade students and the subjects selected by the fourth grade students from the course database that is stored in external memory unit 602 and loads it in the main memory unit 604 and stores it as Course Table 610 (Step S1302). Then, instances of entity “Name” and entity “Subject” which are represented in Course Table 610 on this main memory unit 604 are displayed in the many-to-many RMS window 615 using GUI 614 (Step S1303). Here, all instances of entity “Name” and entity “Subject” may be displayed or a part of the instances of each entity may be displayed in a short listing from the records of Course Table 610 by executing the search operations corresponding to the selection operation on the window using a mouse or a keyboard. In this state, no many-to-many relationship between instances of these two entities is displayed in the many-to-many RMS window 615. Here, integer variables i, k, and r used in the following repetitive processes are declared respectively (Step S1304). These are the variables used for referring to Name N(i), Subject S(k) and record number in Course Table 610 respectively. In subsequent processes, two integer arrays FS and FN used for GUI display process are declared so that FS (k) (k=0, 1, 2, 3, and 4 in the example in FIG. 6) and FN (i) (i=0, 1, 2, and 3 in the example in FIG. 6) can be referenced to. FS (k) is a flag associated with each instance of entity “Subject.” For example, FS (3) is a flag associated with the instance of the subject “History” in the example in FIG. 6. Similarly, FN (i) is a flag associated with each instance of entity “Name.” For example, FN (2) is a flag associated with the instance of name “Chen.”

Next, the user of the information terminal arbitrarily selects n instance(s) among the instances of entity “Name” or n instance(s) among the instances of entity “Subject” by moving the cursor on GUI 613 by using the mouse 609 (Step 1305). Then, check boxes each of which is associated with each instance of another entity is displayed and not of the selected entity. (Step S1306, S1307). In the example in FIG. 9(a), the user of the information terminal selects “Chen” 92 among four instances that are displayed in the column of entity “Name” 81 by moving the cursor 618 on GUI 613 by using the mouse 609 (Step S1305). Any number of instances can be selected in entity “Name” 91 in the many-to-many RMS window 615 as mentioned above and in FIG. 9(a), just an example is shown and in this example, n=1. Since one instance of entity “Name” is selected in the example in FIG. 9(a), the check boxes are displayed on the left side of each instance of entity “Subject”, namely “Mathematics”, “English”, “Science”, “History” and “Sociology” (Step S1306). The subsequent process is explained referring to FIG. 14 since the instance of entity “Name” is selected in the example in FIG. 9(a).

With an example shown in FIG. 14, the steps for displaying the relationships between instances of entity “Name” and instances of entity “Subject” by displaying the check mark in the check box displayed to the left side of entity “Subject” are described below. First, l, k, r, and FS(k) for all values of the range of k, that are used in the iteration processes are initialized to 0 (step S1402). As mentioned above, in the example given in FIG. 9(a), “Chen” is selected, and, “Chen” is represented by N(2) according to Course Table 610. Consequently, in the iteration processes through branching (Step S1409) and incrementing process (Step S1404) to i (starting from i=0), the condition for branching to the branch one (Step S1403) becomes true only when i=2 (that is, i indicates “Chen”). Therefore, only in this case, by incrementing r (Step S1407) in the branch two (Step S1405), and by the iteration process of r in the branch three (Step S1408), N(2) i.e. “Chen” is searched from Course Table 610 in the main memory unit 605. Among instances T1(r), which are instances of entity “Name”, stored in Course Table 610, if a record r matching N(2) i.e. “Chen” is found then the branch two (Step S1405) becomes true, and the above-mentioned FS(k) associated with Subject T2(r) in that record is incremented (Step S1406). In other words, the value of F(k) is incremented after k such that S(k)=T2(r) is obtained. In the example shown in FIG. 9(a), N(2) i.e. Chen matches r=1, 3, 4 in the Course Table of fourth grade of school with reference to FIG. 6. Therefore, all flags FS(1), FS(3) and FS(4) associated respectively with the subjects “English” S(1), “History” S(3) and “Sociology” S(4) included in all records that are found are incremented by 1. As a result, in the example shown in FIG. 9(a), the flags associated with each instance of “Subject” become FS(0)=FS(2)=0 and FS(1)=FS(3)=FS(4)=1. Mentioned above is the process to search the mapping of “Subject” entity to “Chen”, which is the selected instance, from the Course Table 610 located in the main memory unit 604 (Step S705).

Next, the mapping (the relationship among the instances) that is searched is displayed in RMS window (615) on GUI on the display unit. By incrementing k by 1 (Step S1415), and by an iteration process starting with k=0 in the branch six (Step S1416), relationships between the selected instance “Chen”, which is an instance of entity “Name”, and the instances of entity “Subject”, which corresponds to entity “Name” are shown by the process for each instance of entity “Subject” explained below. First, in the branch four (Step S1410), if the conditional expression FS(k)=0 is true, there will not be any check mark in any checkbox located on the left side of instance S(k) of “Subject” in the many-to-many RMS window 615. If there is any check mark this will be removed (Step S1412). This means that the person whose name is selected as the instance of entity “Name” in the previous step S1305 has not taken this subject S(k). If the conditional expression FS(k)=0 is false, whether FS(k)=n or not is checked by the branch five (Step S1411). Since n indicates the number of instances of entity “Name”, which are selected in step S1305, and if the conditional expression in the branch five is true, the checkmark “✓” is displayed in the checkbox located on the left side of the instance S(k) of entity “Subject” in the many-to-many RMS window 615 (Step S1413). This means that all person whose names are selected in step S1305 have taken the subject S(k). Further, if the conditional expression of the branch five is false, the checkmark “-” is displayed in the checkbox located on the left side of the instance S(k) of entity “Subject” in many-to-many window 615 (Step S1414). This means that some of the persons whose names are selected in step S901 have taken the subject S(k). In the example shown in FIG. 9(a), n=1 since “Chen” is the only person whose name is selected. As mentioned previously, FS(0)=FS(2)=0, and FS(1)=FS(3)=FS(4)=1, therefore, the check mark “✓” is displayed in the check boxes 95, 96 and 97 displayed respectively on the left side of “English”, “History” and “Sociology” in FIG. 9(a), whereas the check boxes 98 and 99 displayed respectively on the left side of “Mathematics” and “Science” are empty. In this way, as shown in FIG. 9(a), the relationship in the many-to-many RMS window is displayed. The algorithm for search and check mark display need not be as shown in FIG. 14. Any algorithm that results in the display shown in FIG. 9(a) can be used.

For example, instead of using arrays FS and FN, an algorithm in which check marks etc. are shown based by set operations which are realized in a relational database system may be used. For example, in FIG. 9(b), after the set of subjects which Brown has taken is calculated and the set of subjects which Chen has taken is calculated, the check mark “✓” is shown on the left side of History which is in both sets and the check marks “-” are shown on the left of Mathematics, English, and Sociology which are in the set calculated as the union of the above sets after excluding the intersection of the above sets.

Further, in the present invention, by the process mentioned above, when the subjects which “Chen” has taken are displayed with the help of check marks as shown in FIG. 9(a), other subjects which other person has taken can be displayed easily without executing operations explicitly for searching the relationship with the other person. When “Continue” (Yes) is selected in the branch seven (Step S1417) and then to display is selected in the branch eight (Step S1418) in FIG. 14, the process jumps to the selection process in FIG. 7 (Step S702 or S1305). Further, in steps S1417 and S1408, if the user of the information terminal selects any instance displayed on the many-to-many RMS window without executing the operations explicitly, then the process moves to FIG. 13 to display for another selection, and if the user clicks any check box, the process moves to FIG. 16 (Input).

In the present invention, it is possible to display the mapping representing the relationship by selecting multiple instances on the GUI on the display unit. In the example shown in FIG. 9(b), from the status indicated in FIG. 9(a), the user has moved to the selection process in FIG. 13 (Step S1305), and then has selected “Brown” along with “Chen” by moving the cursor 618 placed on GUI 613 displayed on the display screen 612 with the help of mouse 609. Multiple instances can be selected on GUI in one of several ways. For example 1) by pressing and holding any key on the keyboard and clicking “Brown” using a mouse, or 2) by creating a separate window for selecting an instance of “Name” on GUI 613 and then inputting by using a mouse or keyboard. However, other suitable methods can also be used.

Referring back to FIG. 14, in the example shown in FIG. 9(b), both N(0) and N(2) indicating “Brown” and “Chen” are selected, and in this example n=2. In this example also, according to the search process S705 from step S1402 to S1409 which are exactly the same as the above mentioned process, as the mapping to instances of entity “Subject” from selected instances “Chen” and “Brown”, is searched from Course Table 610 in the main memory unit 604, the following result is obtained and stored in the main memory unit 604. The flag associated with each instance of entity “Subject” is FS(0)=1 for “Mathematics”, FS(1)=1 for “English”, FS(2)=0 for “Science”, FS(3)=2 for “History” and FS(4)=1 for “Sociology”.

Moreover, based on these search results, the many-to-many RMS window 615 is displayed as in FIG. 9(b) in, which is displayed in GUI 613 of display unit 612, through each step of the display process S706 shown in FIG. 14. Here, among the items indicating the instances of the “Subject” entity, a check mark “✓” is displayed in check box 96 located on the left side of “History”. This means that both “Brown” and “Chen” have taken “History”. Further, no check mark is displayed in the check box 99 located on the left side of “Science”, indicating that both “Brown” and “Chen” have not taken “Science”. On the other hand, a check mark “-” is displayed in check boxes 88, 85 and 87 located on the left side of “Mathematics”, “English” and “Sociology” respectively, which indicates that either “Brown” or “Chen” have taken these subjects.

As shown in FIG. 9(a) and FIG. 9(b), by selecting one or more instances of entity “Name”, the user of the information terminal can view the relationship of each instance of entity “Name” with each instance of entity “Subject”; in other words, in the example of FIG. 9(a) and FIG. 9(b), the subjects selected by each person can be displayed in the many-to-many RMS window 615 on GUI.

At this point, the user of this information terminal can select more than one instance of entity “Subject” by moving the cursor 618 with the help of the mouse 609. For example, in the example of GUI shown in FIG. 10, the user of the information terminal has selected two subjects “Mathematics” and “History” from entity “Subject” with the help of the mouse (step S1305). Referring to FIG. 13 again, because instances of “Subject” are selected; the corresponding check boxes 104, 105, 106 and 107 are displayed in pane 101 on the left side of each instance of entity “Name” (Step S1307).

The process here onwards is described with the help of the flowchart given in FIG. 15. However, detailed steps the of process have been described with some omissions since they are almost the same as the steps described with the help of FIG. 14 for displaying mapping to instances of entity “Subject” by selecting any instance of entity “Name”. In the example shown in FIG. 10, “Mathematics” and “History” are selected in the many-to-many RMS windows 615. Consequently, the branch one (Step S1501) of FIG. 15 is true only when k=0 and k=3. A search is executed in the Course Table located in the main memory unit 604 followed by the branch two (Step S1502) and the flags associated with the instances of entity “Name” of matched records are incremented (Step S1503). As a result of successive search processes (Step S705), in the example given in FIG. 10, the flag associated with each instance of entity “Name” is FN(0)=2 for “Brown”, FN(1)=1 for “Fleming”, FN(2)=1 for “Chen” and FN(3)=0 for “Smith”.

Moreover, based on these search results, the check mark “✓” is displayed in check box 104 located on the left side of “Brown”, among the items indicating instances of entity “Name” in the many-to-many RMS window 615 displayed in GUI 613 on display unit 612 through each step of the display process S706 shown in FIG. 15. This indicates that “Brown” has taken both “Mathematics” and “History”. Further, the check mark “-” is displayed in check boxes 105 and 106 located on the left side of “Fleming” and “Chen”. This indicates that “Fleming” and “Chen” have taken either “Mathematics” or “History” but not both. Moreover, no check mark is displayed in the checkbox 107 located on the left side of “Smith”. This indicates that “Smith” has taken neither “Mathematics” nor “History”.

Moreover, in the status shown in FIG. 10, the user of the information terminal can at anytime select one or more instances of entity “Name” or entity “Subject” by moving the cursor 618 in GUI 613 with the help of the mouse 609. This indicates that it is possible to jump at anytime from the branch eight (Step S1518) shown in FIG. 15 to step S1305 shown in FIG. 13.

The method to flexibly display many-to-many relationships in the database table in the main memory unit is explained in this embodiment. Accordingly, the relationship existing between two instances of two entities having a many-to-many relationship can be displayed flexibly and simply. A many-to-many relationship displayed in each step mentioned above is not only displayed but also modified or a new relationship between the displayed entities is added with the help of keyboard and the mouse by using the method in the present invention. Further, the method to make changes in the table stored in the main memory unit is explained.

For example, as shown in FIG. 14 or FIG. 15, as previously mentioned, if the user of the information terminal selects an instance other than the selected instance of entity “Name” or entity “Subject” in the many-to-many RMS window 615 by using the mouse 609, at the branch eight (step S1418 or 1518) in FIG. 14 or 15 to display is selected and the process moves to step 1305 in FIG. 13. Then, mapping from any instance of entity “Name” to instances of entity “Subject” or its reverse mapping can be displayed.

However, in the examples shown in FIG. 14 or FIG. 15, the user of the information terminal uses the mouse 609 to click the check box and not the respective instances of entity “Name” or entity “Subject” and can modify the relationship between the displayed entities and can add a new relationship.

Referring back to FIG. 9(b), when “Brown” and “Chen” are the selected instances of entity “Name” on the display unit, the check mark “✓” is displayed for “History”, the check mark “-” for “Mathematics”, “English” and “Sociology” and no check mark is displayed for “Science” based on the data of the Course Table in the main memory unit. This indicates that “Brown” and “Chen” have not taken “Science.”

In this status, when the user of the information terminal wants to add a new relationship indicating that both “Brown” and “Chen” have taken “Science”, the user operates the mouse 609 to move the cursor over check box 99 which is on the left of “Science” and clicks on the check box 99 (Step S1601). In FIG. 9(b), as nothing is displayed in this check box 99, a check mark “✓” is displayed (Step 1302) in the check box 99 by the execution of the steps through the branch one and the branch two in FIG. 16 and the status changes as shown in FIG. 11. According to this operation, the relationship meaning that both “Brown” and “Chen” have taken “Science” is newly entered and displayed in the many-to-many RMS window 615 on GUI 613. However, this new relationship is not added in the Course Table in the main memory unit at this point.

Further, by referring to FIG. 17, a method to reflect the change on relationships mentioned above to the Course Table, which is in the main memory unit, is explained. Initially, variable “i” and “r” for traversing instances of entity “Name” and records of the Course Table respectively is initialized to 0 (Step S1701). Then, by an iteration process according to an increment process (Step 1703) related to the branch one (Step S1702), the branch six (Step S1712) and i, a new record is added only for each instance N(i) which has been selected at S1305. In the example shown in FIG. 11, since “Brown” and “Chen” are selected, the following process is executed only for these two instances.

Next, a variable Flg for determining whether the record that indicates the relationship to be searched exists on Course Table 610, is initialized to 0 (Step S1704). Then, record r indicating that the instance of entity “Name” is selected in the above mentioned step S1305 and the subject that the person of the instance taken is the instance S(a) selected in the above mentioned step S1601, is searched from the Course Table (step S1705 and S1706) by the iteration process according to the increment process (Step S1708) related to the branch two (Step S1705), the branch four (Step S1709) and r (Step S1708). When such a type of record is found, 1 is assigned to the above mentioned Flg (step S1707). During the iteration process related to r mentioned above by the increment process (Step S1708) related to the branch two (Step 1705), the branch four (Step S1709) and r, in the many-to-many RMS, the Flg value is checked (Step S1710), and when such a type of record is not found, record {N (i), S(a)} is added in the Course table (Step S1711). In the example shown in FIG. 11, regarding the instance “Science” of entity “Subject”, which is added with a checkmark “✓” in the above mentioned Step 1602, since both the records of {N (i)=“Brown”, S (a)=“Science”} and [N (i)=“Chen”, S (a)=“science”}’ are not found in Course Table 610 in FIG. 6, these two records are added in Course Table 610 that is stored in the main memory unit 605.

The method described above is the method to add a relationship or a mapping to the Course Table 610 in the main memory unit 604 by clicking an instance of “Subject” with no check mark, display a check mark being newly displayed thereby. Similarly, the user of the information terminal of the present invention can update the Course Table 610 in the main memory unit 604 by clicking an instance of entity “Subject” with a check mark “-” which means that the instances of “Subject” is map to part of, but not all of, the selected instances of entity “Name.”

For example, as shown in FIG. 11, in the status when the instances “Brown” and “Chen” of entity “Name” is selected, “-” checkmark is displayed in the check box, which is located on the left side of “Mathematics.” This means that either “Brown” or “Chen” has taken Mathematics. Here, the user of the information terminal wants to change the relationship to other relationship which means that both “Brown” and “Chen” has taken Mathematics. The user of the information terminal operates the mouse 609 to move the cursor 618 over the check box, which is on the left of “Mathematics” on GUI 613 and clicks on the check box (Step S1601). In such a case, as a result of processing shown in FIG. 16, which is composed of two branch, “✓” checkmark is displayed in the check box, which is on the left of “Mathematics”.

Referring back to FIG. 17, similar to the steps mentioned above where the relationship concerning “Brown” and “Chen” is added, the iteration process related to an instance of entity “Name” and the record of the Course Table is executed and a record {N (i)=“Chen”, S (a)=“Mathematics”} which is not in the Course Table that is in the main memory unit 604 shown in FIG. 6 is added. In this case, since a record {N (i)=“Brown”, S (a)=“Mathematics”} exists in the Course Table 610 (r=0), the result after assigning 1 to Flg in step S1707 is that the process to add the record in Course Table 610 (step S1711) is not executed.

Similarly, in the example shown in FIG. 11, in the status when instances “Brown” and “Chen” of entity “Name” are selected, “✓” check mark is displayed in the check box, which is located on the left side of “History.” This means that both “Brown” and “Chen” have taken “History.” In other words, there is a relationship between “Brown” and “History” and another relationship between “Chen” and “History.” If the user of the information wants to delete these relationships and wants the state where none of them have taken “History.” The user of the information terminal operates the mouse 609 to move the cursor 618 over the check box, which is on the left of “History” on GUI 613 and clicks the check box (Step S1601). As a result of the branch process shown in FIG. 16 by the many-to-many RMS 606, the check box located on the left side of “History” becomes blank (Step 1603).

Next, by referring to FIG. 18, a method to reflect the change on relationships mentioned above to Course Table, which is in the main memory unit, is explained. First, variables i and r for repeating process for instances of entity “Name” and each record of Course Table are initialized to 0 (Step S1801). Then, the following record is added only for the name N (i) selected in step S702 or S1305 by the iteration process related to N(i) according to the increment process (Step 1803) related to the branch one (Step S1802), the branch five (Step S1809) and i. In the example shown in FIG. 11, since “Brown” and “Chen” are selected, the following process is executed only for these two instances.

Then, in Course Table 610 before reflecting the change on relationships, a search is performed to ascertain whether there is a record indicating a relationship between the instance of entity “Name” selected in Step S702 or Step S1305 and the instance S(a) of entity “Subject” selected in the previously mentioned Step S708 or Step S1601, by using the iteration process related to r that is executed dew to the branch two (Step S1804), the branch four (Step S1808) and the increment process. In the example shown in FIG. 11, as a result of clicking the “History” check box in step S1601, {N(i)=“Brown”, S(a)=“History”} where r=1 and {N(i)=“Chen”, S(a)=“History”} where r=4 are searched by the branch three (Step S1805) and are deleted from the Course Table 610 stored in the main memory unit 605 (Step S1806).

In the description above, detailed steps regarding the case where an arbitrary check box of an instance of “Subject” is clicked in Step S708 have been explained by referring to FIG. 16, FIG. 17, and FIG. 18. As the case where an arbitrary check box of an instance of “Name” is clicked in Step S724 is similar to the case described above, the following steps after Step S724 are not explained in detail by referring to a flow chart.

The following are two of advantages of the method of the present invention compared to the conventional method.

The first advantage is that a two-way display of a many-to-many relationship between two entities is possible through simple operations such as a single mouse click. Presently, the relationship between “Name” and “Subject” is considered. In the example shown in FIG. 1, according to the conventional method, to display the relationship from “Name” to “Subject”, by considering “Chen” as a search key, it is necessary to display the result as shown in FIG. 4 on the display unit, by searching in the Course Table 610 for the fourth grade stored in the main memory unit. The contents displayed here are similar to that of FIG. 9(a) in the present invention. However, the advantage of this invention when compared to the conventional method, is that here onwards, the user operations for the information terminal are simplified while displaying the mapping in a reverse direction from “Subject” to “Name”, thus simplifying the display.

For example, as per the conventional method, starting from status shown in FIG. 3, to obtain the list of persons selecting both “Mathematics” and “History”, the user of the information terminal has to search the Course Table 610 for the fourth grade specifying explicitly “Mathematics” and “History” as search keys, by using the keyboard 608 or the mouse 609. For example, as per the conventional method, after the screen for query is displayed from the status in FIG. 3, it is necessary to display a table shown in FIG. 5 by issuing “SELECT Name FROM Course Table for the fourth grade WHERE Subject=“Mathematics” OR “History”;”. However, as per the present invention, starting from the status of FIG. 9(a) similar to FIG. 4, to obtain the list of persons selecting both “Mathematics” and “History”, it is not necessary to display a new screen for a search query. The relationships are displayed as shown FIG. 9(b) just by selecting both “Mathematics” and “History” by the mouse 609 on the many-to-many RMS screen 615 on the GUI 613. FIG. 5 and FIG. 9(b) show an equivalent content. In other words, in the case of two entities having a many-to-many relationship, from the status in which the relationship from one instance of one entity to another instance of another entity is displayed, a different relationship can be displayed with a single mouse click. As a result, as compared to the conventional method, the advantage of the present invention is that the user of the information terminal can understand instantly the complicated relationships between two entities while switching between interactive relationships.

Furthermore, in the present invention, a new relationship can be added to a many-to-many relationship, a new relationship in a many-to-many relationship can be deleted or changed by simple operations such as a double clicking by the mouse and these operations are interactively done. This is the second advantage of the system regarding the present invention. In the conventional method, for example, if FIG. 4 is displayed after searching “Chen”, a new window must be displayed for addition, deletion or changing the relationship, and it is necessary to change the relationship by entering data for the object in that window. On the other hand, in the method of the present invention, from the status of FIG. 4, “Chen” is selected by a mouse click etc. and then one or more check boxes displayed in various instances of “Subject” can be clicked. Through these two operations any relationship from entity “Name” to entity “Subject” or vice versa can be added, deleted, or changed.

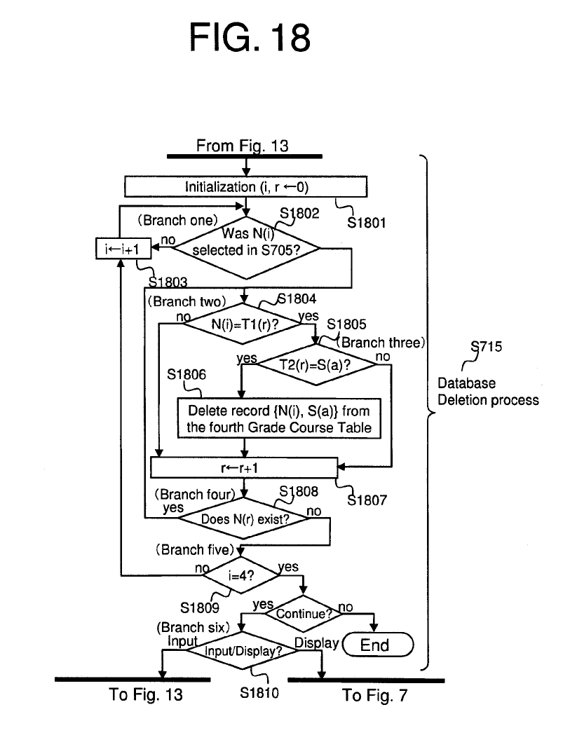

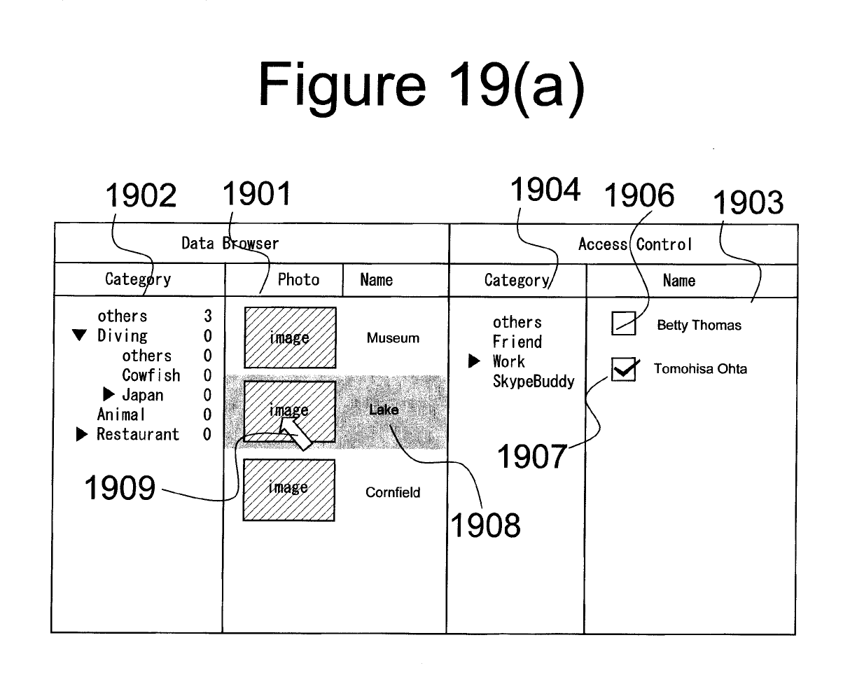

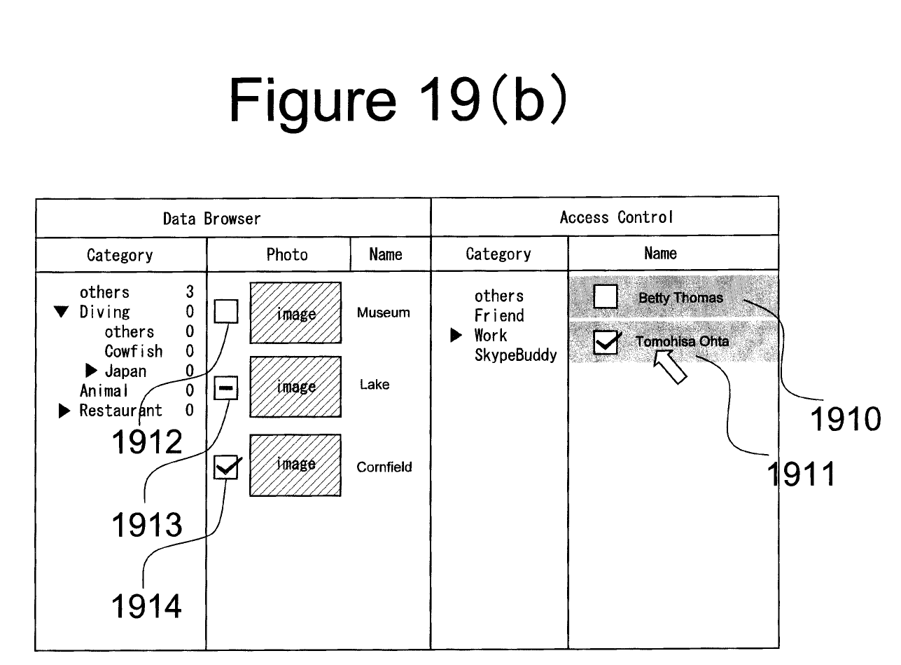

The basic principles of the present invention are described referring to a “Course” as an example of a many-to-many relationship between entity “Name” and entity “Subject.” The present invention can be also applied to displaying a relationship between any entities using a display unit or for inputting a relationship into a database by using an input device. The information stored in the database can be any information such as characters, image information, numeric information, and so on. In the example given in FIG. 19a, a many-to-many relationship between entity “Photograph” 1901 and entity “Recipient of the disclosure” 1903 is displayed on the display device according to the method of the present invention. The user of the information terminal moves the cursor 1909 on the display unit by using the mouse etc. and selects “Lake” 1908, which is one of the instances of entity “Photograph”. From the two instances displayed of entity “Recipient of the disclosure”, a check mark “✓” is displayed in the check box 1907 displayed on the left side of “Tomohisa Ota”. This means that the user of the information terminal has disclosed the photograph of “Lake” to “Tomohisa Ota”.

In this status, the user of the information terminal can at any time select any interface of “Recipient of the disclosure” by moving the cursor with the help of the mouse. In the example shown in FIG. 19b, when the user of the information terminal selects “Betty Thomas” 1910 and “Tomohisa Ota” 1911, which are the interfaces of entity “Recipient of the disclosure”, a check box is displayed on the left side of every instance of entity “Photograph”. The relationship is displayed on the basis of check marks. In the example given in FIG. 19, since the check mark is not displayed in the check box 1912, “Museum”, which is the interface of entity “Photograph”, is not disclosed to both these named persons. Since the check mark “-” is displayed in the check box 1913, “Lake” is disclosed to one of these two named person. Further, since the check mark “✓” is displayed in the check box 1914, it means that “Cornfield” is disclosed to both these named person.

In this way, the present invention is applicable to two entities “Photograph” and “Recipient of the disclosure”. The relationship can be displayed in both ways by a single mouse click: one is for “Which photograph is disclosed to a specific person” relationship and the other is for “To whom the specific photograph is disclosed”. Therefore, the user of the information terminal in the present invention understands the overall concept of the complicated many-to-many relationship between a disclosure target and a disclosed person. Similarly, the user adds, changes or deletes a relationship without any complications.

In various entities of the many-to-many RMS window, a separate window to narrow the instances may be arranged. In the example shown in FIG. 19, narrowing window 1902 is arranged so as to narrow the instances of entity “Photograph” by using the keywords associated with various instances. By using this window, the photographs displayed in the window 1901 can be narrow down. Similarly, in the case of entity “Recipient of the disclosure” also, window 1904 may be arranged for narrowing the instances of the entities by using the keywords associated with various instances. By using this window, names displayed in 1903 can be narrowed for instances display of entity “Recipient of the disclosure”. The narrowing operations for each entity are different. In the present invention, the display method of the relationships between various displayed instances and the input method are executed through the information terminal by following the various steps described above.

### EMBODIMENT 2

According to an example given in another embodiment of the present invention, a user of an information terminal can narrow down the necessary information in an effective manner and display this information on an information terminal display. The narrow-down method for the contact destinations in the phone book or address list is described as an example of the embodiment in the present invention.

The two methods described below may be used to narrow-down the required information by the user of an information terminal, from a large amount of information that exists in a database (such large amount of information is the to be comprised of instances).

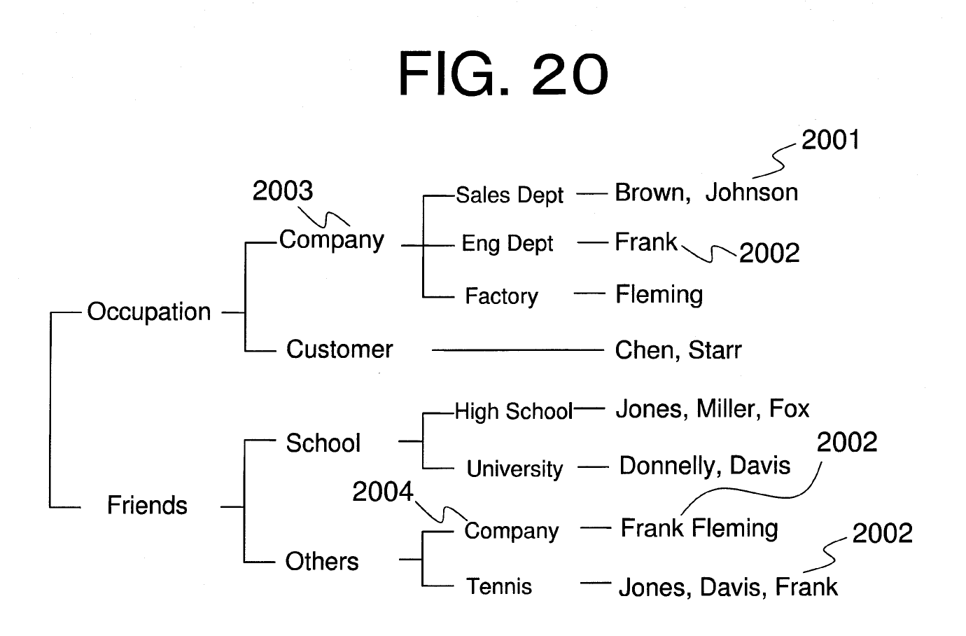

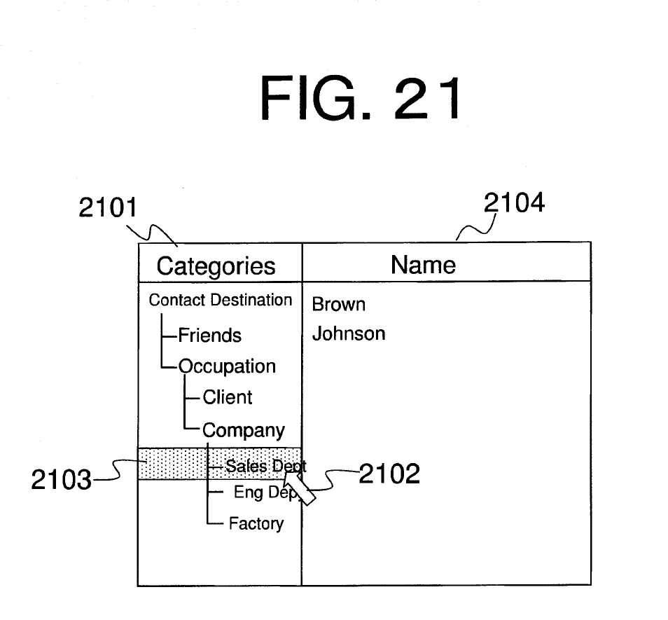

In the first method, all instances are managed by classifying into categories (hereinafter, referred to as Folders) having a tree structure, and when the user of an information terminal narrows-down the required information, the numbers of instances displayed at the display position continue to decrease by following the tree structure from top to bottom. For example, in the database having a tree structure as shown in the example in FIG. 20, in order to search “Johnson” 2001 from Sales department, the GUI representing the tree structure as shown in the example in FIG. 21 is used, and the separate lists that are displayed sequentially from the top level in Categories 2101 can be selected by moving the cursor 2102. When “Sales department” is selected in this way, “Brown” and “Johnson” belonging to the “Sales department” are displayed in “Names” column 2104.

This first method has high retrievability wherein the categories can be selected sequentially from a main category at the top followed by the sub-categories. However, in the actual database, if one instance such as “Frank” 2002 belongs to multiple categories as shown in FIG. 20, the narrow-down and classification processes are very difficult. For example, in the tree-structured database, it cannot be recognized that the three instances of “Frank” 2002 shown in FIG. 20 are the same instance.

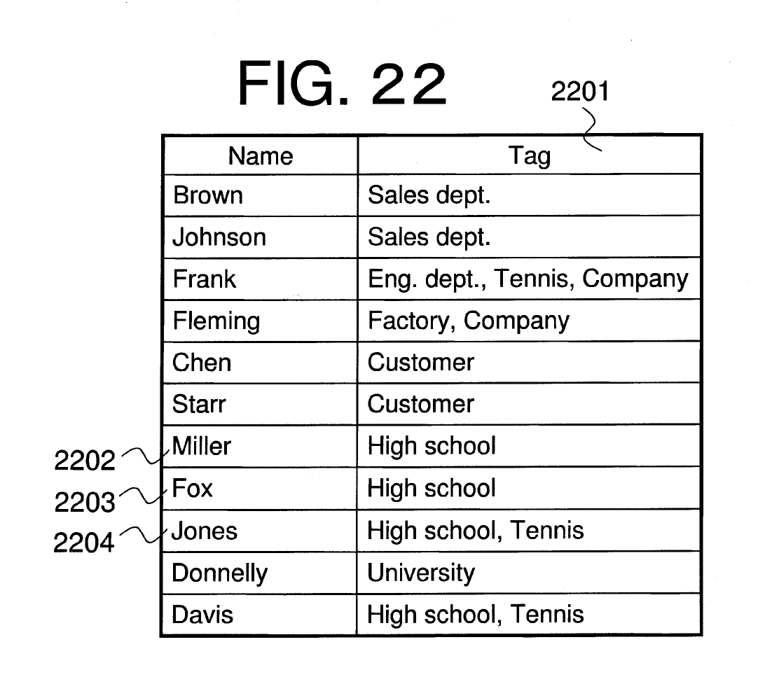

The second method to solve this problem is as follows. In this method, all the instances of Name exist in the database with more than one tag attached, and that tag is searched. Because the tags are used in this method, this method may be called a “Tagging method.” In this tagging method, the information in FIG. 20 exists in the database in the form indicated in FIG. 22. For example, if the user of this information terminal needs to search a high-school friend from multiple instances of Name, the column 2201 of “Tag” of the table shown in FIG. 22 is searched by specifying the “High School” tag as a search key, and three instances “Miller” 2202, “Fox” 2203, and “Jones” 2204 are obtained. In this type of method, since one instance can have multiple tags, the problem in the method of tree-structured folders mentioned above is resolved. However, in this tagging method, when there are too many tags, the hierarchization and the management of the tags becomes difficult which ultimately makes the searching process of tags difficult. Further, even though searching is possible on the basis of categories having a tree structure, multiple tags having the same name cannot be used. For example, in the example shown in FIG. 20, the folder “Company” is located in two places; one is “Company” 2003 below “Occupation” and the other is “Company” 2004 below the second hierarchy of “Friend”. In the tagging method, which does not have a tree structure, there is no method to distinguish these two types of “Company”. The refore, even though “Brown” belongs to “Company” in FIG. 20, it cannot be recognized in FIG. 22.

In other words, the use of any of the two methods mentioned above results in a number of problems. One problem is that it is difficult to classify a single instance into multiple categories, and another problem is that it is difficult to manage instances according to the tree structure hierarchization.

However, the problems mentioned-above in both methods can be resolved using the present invention. For example, the classification into folders in a tree structure, and the tagged tables shown in FIGS. 20 and 22 both can have a many-to-many relationship between the entity called Tag or Folder, and the entity called Name. Therefore, the display of a many-to-many relationship, input method and its information terminals, which are described in the embodiment one mentioned above, can be used.

Let us assume that a plurality of first instances belonging to a first entity are nodes comprising a hierarchic structure such as a tree and that a plurality of second instances belonging to a second entity are associated with first instances. For example, a first instance is one of departments of a company such as the sales department or the engineering department and a second instance is an employee belonging to a department. In this case, if a second instance is associated with a first instance, the second instance is also associated another first instance which is upper to the first instance. For example, if “Brown” is belonging to the sales department, “Brown” is also belonging to the company and the occupation which are upper to the sales department. Between the first entity and the second entity which have such structure there is a many-to-many relationship. Thus the present invention can be applied to the display, the manipulation, and the control of the relationship in this case.

Further, a hierarchic such as a tree structure can be represented by, for example, a table which represents the root node as the topmost node and specifies which node of a tree is upper to which node of the tree.

Moreover, in the present embodiment the term “Category” is used to as the term equivalent to tag or folder as described above. In the description given below, a many-to-many relationship between the entities “Category” and “Name” are displayed as a two-way relationship by using the check boxes displayed on the display unit, and the check mark “✓” and “-”. In order to input in both ways by selecting the check box through a mouse, since the method to coordinate the software and hardware resources and represent these resources is same as the procedure described in the embodiment one mentioned above, an explanation is omitted here and the effect displayed in the display unit is described as its result.

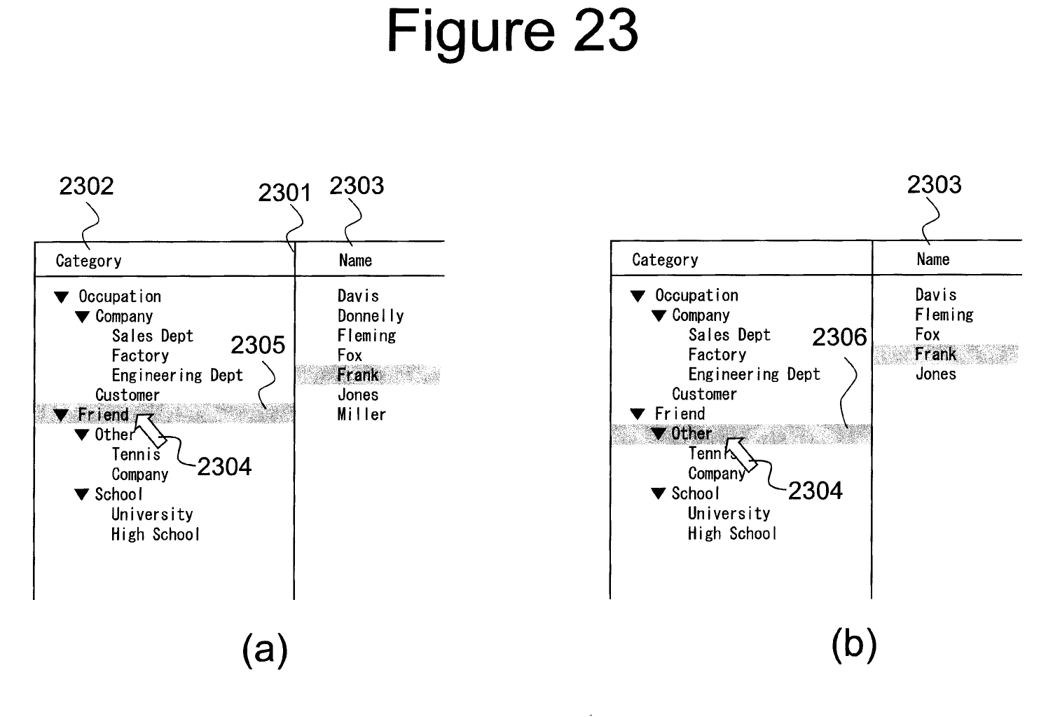

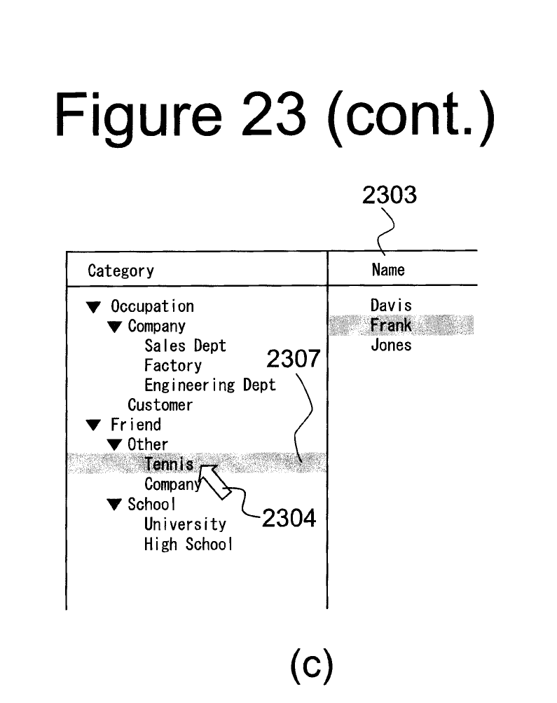

A method to display and input a many-to-many relationship between the Category and Name in the tree structure indicated in FIG. 20, and the narrow-down method in the present invention are shown in FIG. 23a to FIG. 25. The window consists of instance display window 2302 for entity “Category” and instance display window 2303 for entity “Name”. First, referring to FIG. 23(a), the user of the information terminal can select “Friend”, which is one of the hierarchized instances of entity “Category”, by moving the cursor 2304 on the display unit. As a result, the names of all seven persons “Davis”, “Donnelly”, “Fleming”, “Fox”, “Frank”, “Jones”, and “Miller” belonging to the category under Friend shown in FIG. 20 are displayed in window 2303 for entity “Name”. Further, in FIG. 23(b), if the user of the information terminal selects “Others” 2306 under “Friend”, the list of names of the above-mentioned seven persons is narrowed down to four persons “Davis”, “Fleming”, “Frank”, and “Jones” belonging to the hierarchy under “Others”. In FIG. 23(c), if the user selects “Tennis” 2307, which is one of the categories under “Others”, the list of names of the above-mentioned four persons is narrowed down to three persons “Davis”, “Frank”, and “Jones”. This method is similar to the display and input method for narrowing-down of the folders in the tree structure, which is the first method mentioned previously.

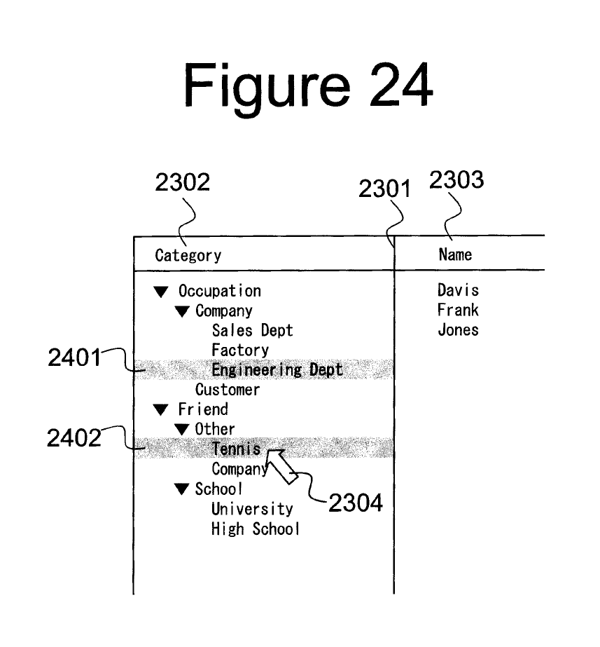

In FIG. 24, if the user of the terminal selects both “Engineering Dept.” and “Tennis” of entity “Category”, the names of persons belonging to “Engineering Dept.” and “Tennis” category are displayed in window 2303 indicating the instance of entity “Name”. In the first method i.e. folders in a tree structure, “Frank” 2002 shown in FIG. 20 exists in both “Engineering Dept.” and “Tennis” folders. Therefore, when multiple folders are selected as shown in FIG. 24, both “Frank”s are displayed in the “Name” window. In the method of the present embodiment of the present invention, “Engineering Dept.” and “Tennis”, which are the instances of entity “Category”, are displayed on the basis of database information by the method described in detail in the embodiment one of the present invention mentioned previously, as a many-to-one relationship with “Frank”, which is the instance of entity “Name”. In other words, it can be identified that “Frank”, which is associated with “Engineering Dept.” and “Tennis” that are the instances of entity “Category”, has a relationship with one “Frank” in entity “Name”. Consequently, in the method of the present embodiment, even though “Engineering Dept.” and “Tennis” are both selected after the instances in “Name” are narrowed down by the same operations as in the case of a tree structure, the name of persons among “Davis”, “Frank”, and “Jones” belonging to either of “Engineering Dept.” or “Tennis” is displayed without displaying “Frank” twice in “Name” window 2303.

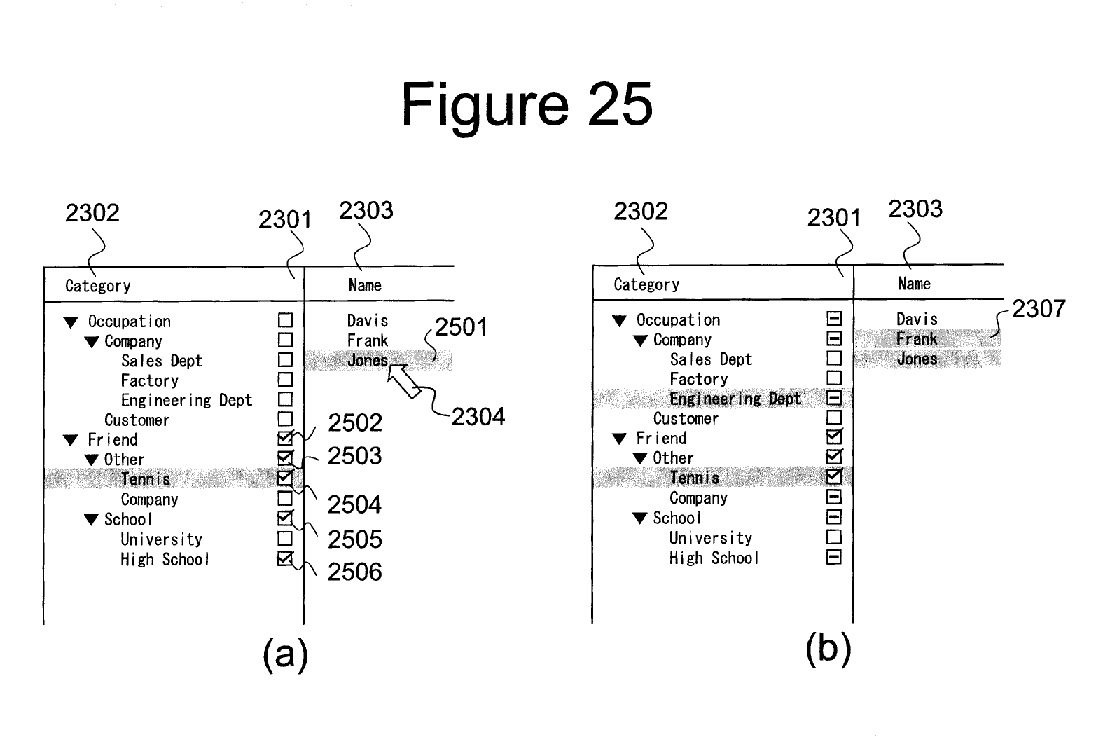

From the status in FIG. 24, the user of the information terminal can select any instance displayed in “Name” at any time by moving the cursor 2304 on display unit through a mouse. For example, as shown in FIG. 25(a), when “Jones” 2501 is selected, the check boxes corresponding to each instance of entity “Category” are displayed. This represents the relationship between “Jones” and entity “Category”, and it is displayed with the help of check marks “✓” that “Jones” belonging to “Tennis” 2504 also belongs to “Others” located one level above and to “Friend” located one level above “Others”. Further, “Jones” also belongs to “High School” 2506 of entity “Category” and so to “School” 2505 located one level above, and it is also displayed with the help of check marks “✓”

As described in the embodiment one mentioned-above, from the status shown in FIG. 25(a), after selecting the instance of another entity “Name”, the relationship for that “Category” can be displayed and after selecting any instance of entity “Category”, a name belonging to that category can be displayed in window 2303. The displayed relationship can be updated, deleted or a new relationship can also be added by moving the cursor 2304 over the check box that is displayed for each instance of “Category” and clicking it.

Moreover, after multiple selection of each instance of entity “Category” and the entity “Name”, the relationship of that instance can be displayed or input or modification, deletion and addition can be executed. As shown in FIG. 25(b), from the status of FIG. 24, when two instances of “Frank” and “Jones” are selected, a check mark “✓” is displayed on the left side of the instance of entity “Category” to which both “Frank” and “Jones” belong, and “-” is displayed on the left side of the instance of entity “Category” to which either of “Frank” or “Jones” belong.

In this way, in the embodiment two, since the instances of entity “Category” has the same tree structure as that is used in the first method mentioned-above, the narrow-down process as in the first method mentioned-above can be easily done and the advantages described in the above-mentioned embodiment one can be obtained. Therefore, as the tagging method, which is the second method mentioned-above, is advantageous, correlating one instance of “Name” with multiple instances of “Categories” is also advantageous.

Any entity can be used in the embodiment two. For example, an information terminal is provided with any character information including not only name but also address, e-mail address, telephone number etc., any image data such as photos and any numerical information, and these entities can be searched or narrowed-down efficiently. Moreover, similar to the embodiment one, in the embodiment two also, the program, which is executed by coordination with each component of an information terminal, and the database can be stored in a memory unit of this information terminal or on a server available on another terminal of the network.

In the embodiment one mentioned previously and the embodiment two, the information terminal that can change, add, delete, and display a many-to-many relationship between two entities easily as a two-way relationship, is provided. Alternatively, the difference between the embodiment one and the embodiment two is that the embodiment one has a symmetric display of a two-way instance and relationship between two entities, whereas the embodiment two has an asymmetric display. Specifically, in the embodiment two, when the instance of entity “Category” is selected, the check boxes to display and input the relationships displayed in the embodiment one are not displayed for the instances of entity “Name”. Further, in the case of the embodiment one, even though an instance of one of the entities is selected, the displayed instance of another entity does not change, however, in the case of the embodiment two, when the instance of entity “Category” is selected, the instance of entity “Name” also changes accordingly, and the instances of entity “Name” are narrowed down while moving towards lower hierarchies of “Category” instance. In this way the classification and search of simple information where categories are used is possible in the embodiment two.

What is claimed is:

1. A database system comprising:
a database, the database storing one or a plurality of relationships existing between a plurality of first instances belonging to a first entity and a plurality of second instances belonging to a second entity;
a microprocessor, the micro processor searching the database, when one or a plurality of the first instances are selected as a first selected set among the plurality of the first instances, for a first relationship existing between a instance in the first selected set and one of the plurality of the second instances, and the microprocessor searching the database, when one or a plurality of the second instances are selected as a second selected set among the plurality of the second instances, for a second relationship existing between one of the plurality of the first instances and an instance in the second selected set; and
a display device, the display device displaying a first pane and a second pane, the display device displaying a first list which includes the plurality of the first instances in the first pane and displaying a second list which includes the plurality of the second instances in the second pane, and the display device displaying the first relationship or the second relationship in the first pane or the second pane.

2. The database system according to claim 1, wherein the display device highlights, when displaying the first relationship or the second relationship, an instance of the plurality of the first instances or an instance of the plurality of the second instances, the first relationship or the second relationship existing the instance of the plurality of the first instances and the instance of the plurality of the second instances.

3. The database system according to claim 2, wherein the display device highlights the instance of the plurality of the second instances for displaying the first relationship and highlights the instance of the plurality of the first instances for displaying the second relationship.

4. The database system according to claim 3, wherein the display device displays the first list and the second list, the first list or the second list being displayed so that a display region in which a mark can be displayed internally is displayed at a side of each instance in the first list or the second list when displaying the second relationship or the first relationship.

5. The database system according to claim 4, wherein the mark displayed at a side of each instance in the first list is displayed differently depending on the number of instances in the second selected list such that there exists a first relationship between each instance in the first list and one of the instances in the second selected list, and the mark displayed at a side of each instance in the second list is displayed differently depending on the number of instances in the first selected list such that there exists a second relationship between one of the instances in the first selected list and the each instance in the second list.

6. The database system according to claim 4, wherein the display region is a check box.

7. The database system according to claim 2, wherein the instance of the plurality of the first instances included in the first list and the instance of the plurality of the second instances in the second list are displayed by using characters and the instance of the plurality of the first instances or the instance of the plurality of the second instances are highlighted by changing fonts of the characters.

8. The database system according to claim 1, wherein the microprocessor deletes from the database a relationship which existed between an instance of the first selected set and an instance of the one or the plurality of the second instances which is selected after the first relationship has been displayed or between an instance of the one or the plurality of the first instances which is selected and an instance of the second selected set after the second relationship has been displayed.

9. The database system according to claim 1, wherein the microprocessor causes the database to store a relationship between an instance of the first selected set and an instance of the one or the plurality of the second instances which is selected after the first relationship has been displayed or between an instance of the one or the plurality of the first instances which is selected and an instance of the second selected set after the second relationship has been displayed.

10. The database system according to claim 9, wherein the microprocessor causes the database to store the relationship unless the relationship has been stored in the database.

11. The database system according to claim 1, wherein the plurality of the first instances belonging to the first entity form a hierarchical structure and the database stores a relationship between a first instance and a second instance if the database stores another relationship between another first instance lower than the first instance and the second instance.

12. A database system comprising:
a database, the database storing one or a plurality of relationships between a plurality of first instances belonging to a first entity and a plurality of second instances belonging to a second entity;
a microprocessor, the microprocessor searching the database, when a third instance and a fourth instance are selected from the plurality of the first instances, for one or a plurality of fifth instances in the plurality of the second instances wherein one or a plurality of first relationships exist between the one or the plurality of the fifth instances and the third instance or between the one or the plurality of the fifth instances and the fourth instance at a first condition, and searching the database for one or a plurality of sixth instances in the plurality of the second instances wherein one or a plurality of second relationships exist between the one or the plurality of the sixth instances and the third instance and/or between the one or the plurality of the sixth instances and the fourth instance at a second condition; and,
a display device for displaying a first pane and a second pane, the display device displaying a first list which includes the plurality of the first instances in the first pane and displaying a second list which includes the plurality of the second instances in the second pane, the display device displaying the one or the plurality of the first relationships, which exists between the one or the plurality of the fifth instances and the third instance or between the one or the plurality of the fifth instances and the fourth instance, in a first mode, and the display device displaying the one or the plurality of the second relationships, which exists between the one or the plurality of the sixth instances and the third instance and/or between the one or the plurality of the sixth instances and the fourth instance, in a second mode.

13. The database system according to claim 12, wherein the one or the plurality of the first relationships exist both between the one or the plurality of the fifth instances and the third instance and between the one or the plurality of the fifth instances and the fourth instance, and wherein the one or the plurality of the second relationships exist either between the one or the plurality of the fifth instances and the third instance or between the one or the plurality of the fifth instances and the fourth instance.

14. A display method in an information terminal having a database storing one or a plurality of relationships existing between a plurality of first instances belonging to a first entity and a plurality of second instances belonging to a second entity and a display device displaying a first pane and a second pane, the display device displaying a first list which includes the plurality of the first instances in the first pane and displaying a second list which includes the plurality of the second instances in the second pane, the display method comprising:
searching the database, when one or a plurality of the first instances are selected as a first selected set among the plurality of the first instances, for a first relationship existing between an instance in the first selected set and one of the plurality of the second instances and displaying the first relationship on the display device; and
searching the database, when one or a plurality of the second instances are selected as a second selected set among the plurality of the second instances, for a second relationship existing between one of the plurality of the first instances and an instance in the second selected set and displaying the second relationship on the display device.

15. The display method of an information terminal according to claim 14, wherein the first relationship or the second relationship is displayed by highlighting the one of the plurality of the second instances or the one of the plurality of the first instances wherein the first relationship or the second relationship exists between the one of the plurality of the second instances and the one of the plurality of the first instances.

16. The display method of an information terminal according to claim 15, wherein the instance of the plurality of the second instances are highlighted for displaying the first relationship and the instance of the plurality of the first instances are highlighted for displaying the second relationship.

17. The display method of an information terminal according to claim 16, wherein the first list or the second list is displayed so that a display region in which a mark can be displayed internally is displayed at a side of each instance in the first list or the second list when displaying the second relationship or the first relationship.

18. The display method of an information terminal according to claim 17, wherein the mark displayed at a side of each instance in the first list is displayed differently depending on the number of instances in the second selected list such that there exists a first relationship between each instance in the first list and one of the instances in the second selected list, and the mark displayed at a side of each instance in the second list is displayed differently depending on the number of instances in the first selected list such that there exists a second relationship between one of the instances in the first selected list and each instance in the second list.

19. The display method of an information terminal according to claim 17, wherein the display region is a check box.

20. The display method of an information terminal according to claim 15, wherein the instance of the plurality of the first instances included in the first list and the instance of the plurality of the second instances in the second list are displayed by using characters and the instance of the plurality of the first instances or the instance of the plurality of the second instances are highlighted by changing fonts of the characters.
